(19) United States
(12) Patent Application Publication
(10) Pub. No.: US 2025/0348747 A1
(43) Pub. Date: Nov. 13, 2025

(54) REINFORCEMENT LEARNING FOR INVERSE PROBLEM SIMULATOR MODELS

(71) Applicant: QUALCOMM Incorporated, San Diego, CA (US)

(72) Inventors: Fabio Valerio MASSOLI, Amsterdam (NL); Thomas Markus HEHN, Delft (NL); Tribhuvanesh OREKONDY, Wettingen (SE); Arash BEHBOODI, Amsterdam (NL)

(21) Appl. No.: 18/661,511

(22) Filed: May 10, 2024

(51) Int. Cl. G06N 3/092

(52) U.S. Cl. CPC G06N 3/092

(57) ABSTRACT

Systems and techniques are provided for optimizing simulation parameters of non-differentiable simulators. A surrogate neural network trained to approximate a simulator model can generate one or more surrogate predictions based on processing a first set of parameter values and stochastic input data associated with the simulator model. A state vector indicative of the first set of parameter values and the one or more surrogate predictions can be generated, and used to determine an action corresponding to a trained agent of a reinforcement learning (RL)-based policy network, wherein the action is indicative of a decision to re-train the surrogate neural network or a decision not to re-train the surrogate neural network. A second set of parameter values corresponding to the parameters of the simulator model can be generated by updating the first set of parameter values using the action and one or more gradients determined for the surrogate neural network.

### FIELD

The present disclosure generally relates to simulation processing for inverse problems. For example, aspects of the present disclosure relate to systems and techniques for inverse problem simulation using one or more reinforcement learning machine learning networks.

### BACKGROUND

Many devices and systems allow video data to be processed and output for consumption. Digital video data includes large amounts of data to meet the demands of consumers and video providers. For example, consumers of video data desire high quality video, including high fidelity, resolutions, frame rates, and the like. As a result, the large amount of video data that is required to meet these demands places a burden on communication networks and devices that process and store the video data.

An artificial neural network attempts to replicate, using computer technology, logical reasoning performed by the biological neural networks that constitute animal brains. Deep neural networks, such as convolutional neural networks, are widely used for numerous applications, such as object detection, object classification, object tracking, big data analysis, among others. For example, convolutional neural networks are able to extract high-level features, such as facial shapes, from an input image, and use these high-level features to output a probability that, for example, an input image includes a particular object.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Disclosed are systems, methods, apparatuses, and computer-readable media for inverse problem optimization with reinforcement learning. According to at least one illustrative example, a method of is provided, the method including: obtaining a first set of parameter values corresponding to parameters of a simulator model; processing stochastic input data associated with the simulator model and the first set of parameter values using a surrogate neural network to generate one or more surrogate predictions, wherein the surrogate neural network is trained to approximate the simulator model; generating a state vector indicative of the first set of parameter values for the simulator model and the one or more surrogate predictions; determining an action corresponding to a trained agent of a reinforcement learning (RL)-based policy network, wherein the action is determined based on the state vector, and wherein the action is indicative of a decision to re-train the surrogate neural network or a decision not to re-train the surrogate neural network; and generating a second set of parameter values corresponding to the parameters of the simulator model, wherein the second set of parameter values are generated based on using the action and one or more gradients determined for the surrogate neural network to update the first set of parameter values.

In another illustrative example, an apparatus for inverse problem optimization with reinforcement learning is provided. The apparatus includes at least one memory and at least one processor coupled to the at least one memory and configured to: obtain a first set of parameter values corresponding to parameters of a simulator model; process stochastic input data associated with the simulator model and the first set of parameter values using a surrogate neural network to generate one or more surrogate predictions, wherein the surrogate neural network is trained to approximate the simulator model; generate a state vector indicative of the first set of parameter values for the simulator model and the one or more surrogate predictions; determine an action corresponding to a trained agent of a reinforcement learning (RL)-based policy network, wherein the action is determined based on the state vector, and wherein the action is indicative of a decision to re-train the surrogate neural network or a decision not to re-train the surrogate neural network; and generate a second set of parameter values corresponding to the parameters of the simulator model, wherein the second set of parameter values are generated based on using the action and one or more gradients determined for the surrogate neural network to update the first set of parameter values.

In another example, a non-transitory computer-readable medium is provided that includes instructions that, when executed by at least one processor, cause the at least one processor to: obtain a first set of parameter values corresponding to parameters of a simulator model; process stochastic input data associated with the simulator model and the first set of parameter values using a surrogate neural network to generate one or more surrogate predictions, wherein the surrogate neural network is trained to approximate the simulator model; generate a state vector indicative of the first set of parameter values for the simulator model and the one or more surrogate predictions; determine an action corresponding to a trained agent of a reinforcement learning (RL)-based policy network, wherein the action is determined based on the state vector, and wherein the action is indicative of a decision to re-train the surrogate neural network or a decision not to re-train the surrogate neural network; and generate a second set of parameter values corresponding to the parameters of the simulator model, wherein the second set of parameter values are generated based on using the action and one or more gradients determined for the surrogate neural network to update the first set of parameter values.

In another example, an apparatus is provided. The apparatus includes: means for obtaining a first set of parameter values corresponding to parameters of a simulator model; means for processing stochastic input data associated with the simulator model and the first set of parameter values using a surrogate neural network to generate one or more surrogate predictions, wherein the surrogate neural network is trained to approximate the simulator model; means for generating a state vector indicative of the first set of parameter values for the simulator model and the one or more surrogate predictions; means for determining an action corresponding to a trained agent of a reinforcement learning (RL)-based policy network, wherein the action is determined based on the state vector, and wherein the action is indicative of a decision to re-train the surrogate neural network or a decision not to re-train the surrogate neural network; and means for generating a second set of parameter values corresponding to the parameters of the simulator model, wherein the second set of parameter values are generated based on using the action and one or more gradients determined for the surrogate neural network to update the first set of parameter values.

In some aspects, one or more of the apparatuses described herein is, is part of, or includes a mobile device (e.g., a mobile telephone or so-called “smart phone”, a tablet computer, or other type of mobile device), a wearable device, an extended reality (XR) device (e.g., a virtual reality (VR) device, an augmented reality (AR) device, or a mixed reality (MR) device), a vehicle (or a computing device of a vehicle), a personal computer, a laptop computer, a video server, a television (e.g., a network-connected television), or other device. In some aspects, the apparatus includes at least one camera for capturing one or more images or video frames. For example, the apparatus(es) can include a camera (e.g., a red-green-blue (RGB) camera) or multiple cameras for capturing one or more images and/or one or more videos including video frames. In some aspects, the apparatus(es) includes a display for displaying one or more images, videos, notifications, or other displayable data. In some aspects, the apparatus(es) includes at least one transmitter (or at least one transceiver) configured to transmit one or more video frame and/or syntax data over a transmission medium to at least one device. In some aspects, the at least one processor of the apparatus noted above includes a neural processing unit (NPU), a central processing unit (CPU), a digital signal processor (DSP), a graphics processing unit (GPU), or other processing device or component.

Aspects generally include a method, apparatus, system, computer program product, non-transitory computer-readable medium, user device, user equipment, wireless communication device, and/or processing system as substantially described with reference to and as illustrated by the drawings and specification.

Some aspects include a device having a processor configured to perform one or more operations of any of the methods summarized above. Further aspects include processing devices for use in a device configured with processor-executable instructions to perform operations of any of the methods summarized above. Further aspects include a non-transitory processor-readable storage medium having stored thereon processor-executable instructions configured to cause a processor of a device to perform operations of any of the methods summarized above. Further aspects include a device having means for performing functions of any of the methods summarized above.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims. The foregoing, together with other features and aspects, will become more apparent upon referring to the following specification, claims, and accompanying drawings.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim. The foregoing, together with other features and aspects, will become more apparent upon referring to the following specification, claims, and accompanying drawings.

### BRIEF DESCRIPTION OF THE DRAWINGS

The accompanying drawings are presented to aid in the description of various aspects of the disclosure and are provided solely for illustration of the aspects and not limitation thereof. So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 illustrates an example implementation of a system-on-a-chip (SOC), in accordance with some examples;

FIG. 2A illustrates an example of a fully connected neural network, in accordance with some examples;

FIG. 2B illustrates an example of a locally connected neural network, in accordance with some examples;

FIG. 2C illustrates an example of a convolutional neural network, in accordance with some examples;

FIG. 3A is a diagram illustrating an example of a forward process associated with a simulator model, in accordance with some examples;

FIG. 3B is a diagram illustrating an example of a training process for a simulator model and a surrogate machine learning network, in accordance with some examples;

FIG. 4A is a diagram illustrating an example of a surrogate machine learning network that can be used to approximate a simulator model, in accordance with some examples;

FIG. 4B is a diagram depicting an example of an actor neural network 430 that can be included in a reinforcement learning policy network, in accordance with some examples;

FIG. 4C is a diagram illustrating an example of a critic neural network 460 that can be included in a reinforcement learning policy network and used to train the actor neural network of FIG. 4B, in accordance with some examples;

FIG. 5 is a diagram illustrating an example of a reinforcement learning (RL)-based process for training one or more agents of a policy network to minimize the number of calls made to a simulator, in accordance with some examples;

FIG. 6 is a diagram illustrating an example of a reward model that can be used to train a policy network to determine when to perform simulator calls, in accordance with some examples;

FIG. 7 is a diagram illustrating an example of a first simulation scenario and a second simulation scenario that can be included in a family or class of multiple related inverse problems associated with a black-box simulator, in accordance with some examples;

FIG. 8 is a flow chart diagram illustrating an example of a process for simulation parameter optimization, in accordance with some examples;

FIG. 9 is a block diagram illustrating an example of a deep learning network, in accordance with some examples;

FIG. 10 is a block diagram illustrating an example of a convolutional neural network, in accordance with some examples; and

FIG. 11 illustrates a detailed example of a deep convolutional network (DCN) designed to recognize visual features from an image, in accordance with some examples;

FIG. 12 is a block diagram illustrating a deep convolutional network (DCN), in accordance with some examples; and

FIG. 13 illustrates an example computing device architecture of an example computing device which can implement the various techniques described herein.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the scope of the application as set forth in the appended claims.

Computer-based simulation techniques can be used to perform modeling of complex real-world systems and interactions, and may be used to determine estimates of the system's parameters or characteristics given a set of input conditions and/or constraints. In some examples, simulators may be implemented based on computational models and/or machine learning networks that are opaque to a user of the simulator, and may generate non-deterministic outputs for a given set of input data. Simulators with an internal structure or operation that is opaque to the user may also be referred to as “black-box” simulators.

For example, a black-box simulator or simulation model can receive a set of inputs and generate a corresponding one or more outputs, but the internal mechanics and computations associated with the transformation between the input and the output are hidden from the user. The internal structure and computations performed by a black-box simulator may be unknown and/or inaccessible to the user of the black-box simulator, and the user may be unable to inspect or directly modify equations, logic, intermediate steps, etc., that are implemented by the black-box simulator between the input and the output.

In some cases, black-box simulators are often used when the simulation's complexity is high (e.g., the process to be simulated is a relatively high complexity process). For example, black-box simulators can be used for high complexity simulations, where a focus of the simulation may be on obtaining an accurate output rather than process understanding. Black-box simulators can be used for high complexity simulations in various science and engineering fields, among various others. Black-box simulators can also be used for performing moderate or low complexity simulations.

Black-box simulators may implement forward simulation techniques, where simulation parameters and input data are mapped to output observations. For example, a black-box simulator for particle physics can be configured to simulate the detection of a particular particle type (e.g., the output observation), given inputs comprising the properties of particles entering the detector (e.g., the input data) and the detector settings (e.g., the simulation parameters). Forward simulation techniques can be used to solve or model forward problems, starting from causal factors and then predicting the effects or output observations produced by the causal factors.

In forward problems, known causal factors (e.g., known properties or parameters of a system) are used to predict a produced (e.g., corresponding) outcome. Inverse problems may be formulated as the opposite (e.g., inverse) of forward problems. Inverse problems are associated with determining underlying parameters or causes from observed outcomes, for example starting from the effects and then calculating the causes. Inverse problems exist across many science and engineering fields, corresponding to a class of problems that may be characterized as having a goal of finding the input parameters that could have produced the observed data, given a forward model. While forward models simulate a system and provide output data for given input parameters, the process is reversed in inverse problems, which start from the output data and aim to infer the input parameters.

Many inverse problems describe processes where the parameters are not and cannot be directly observed. Inverse problems have wide application in optics, radar, acoustics, wireless or radio frequency (RF) communications, signal processing, medical imaging, computer vision, etc., among various other fields.

Solving or modeling inverse problems can be challenging cased on the indirect nature of the observation of the quantities or parameters of interest. Additional complexities of solving or modeling inverse problems may be associated with a lack of a unique solution for some inverse problems, a solution that does not depend continuously on the data for some inverse problems, or some inverse problems that may be inherently unstable.

In some cases, black-box simulators and forward simulation techniques are used to solve or model inverse problems. The use of black-box simulators in inverse problems can be beneficial because a detailed analytical representation of the forward model is not required to implement the black-box simulator (e.g., for inverse problems, the forward analytical representation is unavailable and a goal of solving the inverse problem is to calculate these causal factors that produce an observation).

Machine learning networks and/or machine learning techniques can be used to solve inverse problems for black-box simulators. For example, the black-box simulator may describe a forward process ƒ: (ψ, x)→y, where the black-box simulator forward process uses simulation parameters ψ and input data x to determine observations y. An inverse problem associated with the black-box simulator can be to optimize ψ (e.g., the simulation parameters) to minimize a configured observation loss for the simulator. The simulation parameters ψ can be parameters used (e.g., by the black-box simulator) to configure and/or perform the simulation.

In some cases, the optimization of the simulation parameters ψ can be performed based on evaluating the forward model (e.g., the underlying forward model associated with the black-box simulator) to obtain the simulator gradients. The gradients of a black-box simulator may be unavailable or difficult to obtain, for example based on the forward model being computationally expensive to evaluate. In some cases, simulator gradients may be unavailable or difficult to obtain based on the black-box simulator being non-differentiable (e.g., where the simulator output cannot be differentiated with respect to the simulator input parameters). When a simulator is non-differentiable, small changes in the input parameters to the simulator do not necessarily correspond to smooth or continuous changes in the output.

For example, the output of a non-differentiable simulator may include jumps or discontinuities, each representing a point at which the simulator is non-differentiable and a simulator gradient cannot be directly determined. In some examples, one or more stochastic processes may be represented within the opaque internal logic of a non-differentiable black-box simulator, which can cause non-smoothness in the simulator output and may introduce challenges in determining the simulator gradients. In some cases, the relationship between the input parameters and the output is not expressible as a closed-form mathematical expression, and it may be difficult or impossible to compute the simulator gradients analytically.

Systems and techniques that can be used to solve inverse problems for black-box simulators while utilizing a reduced quantity of forward model evaluations may be beneficial. For example, systems and techniques that can be used to optimize parameters of black-box simulators while reducing or minimizing the number of simulator calls (e.g., forward model evaluations) can be beneficial. Systems and techniques that can be used to optimize parameters of non-differentiable black-box simulators can also be beneficial.

Systems, apparatuses, methods (also referred to as processes), and computer-readable media (collectively referred to as “systems and techniques”) are described herein that can be used to perform simulation processing for inverse problems (e.g., optimization of simulation parameters for non-differentiable black-box simulators, etc.) and/or classes or families of related inverse problems, while minimizing the number of calls to the simulator and forward model evaluations that are performed. For example, the systems and techniques can be used to solve one or more related inverse problems associated with optimizing the simulation parameters of a black-box non-differentiable simulator. Reinforcement learning (RL) machine learning networks and techniques can be used to train an active learning policy for the training of a differentiable surrogate model to approximate the black-box non-differentiable simulator.

For example, the active learning policy can be used to guide the training of a surrogate model that can be used to generate differentiable samples approximating the output of the non-differentiable black-box simulator. In some aspects, the surrogate can be a learned differentiable model that can be learned for a single black-box simulator inverse problem (e.g., optimization of a single black-box simulator). In some cases, the surrogate is a learned differentiable model that can be used to solve a family or class of multiple related black-box simulator inverse problems (e.g., optimizations of multiple simulators or simulator configurations, etc.). The gradients of the learned differentiable surrogate can then be determined and used to optimize the non-differentiable simulation parameters through gradient descent. The active learning policy can be used to guide the training of the differentiable surrogate, and can be configured (e.g., using reinforcement learning for the policy) to minimize or reduce the number of simulator calls and forward model evaluations used for training the differentiable surrogate.

In some aspects, the systems and techniques described herein can be used to optimize the simulation parameters ψ of a stochastic black-box and non-differentiable simulator by performing stochastic gradient descent. As noted previously, black-box simulators may be unsuitable for automatic differentiation techniques, and are often non-differentiable by analytical techniques. In one illustrative example, a surrogate machine learning network (e.g., a surrogate neural network) can be trained to locally (e.g., within the parameter space w/of the simulator) approximate the simulator, and gradients of the local surrogate(s) can subsequently be used to perform the optimization over ψ.

Various aspects of the present disclosure will be described with respect to the figures.

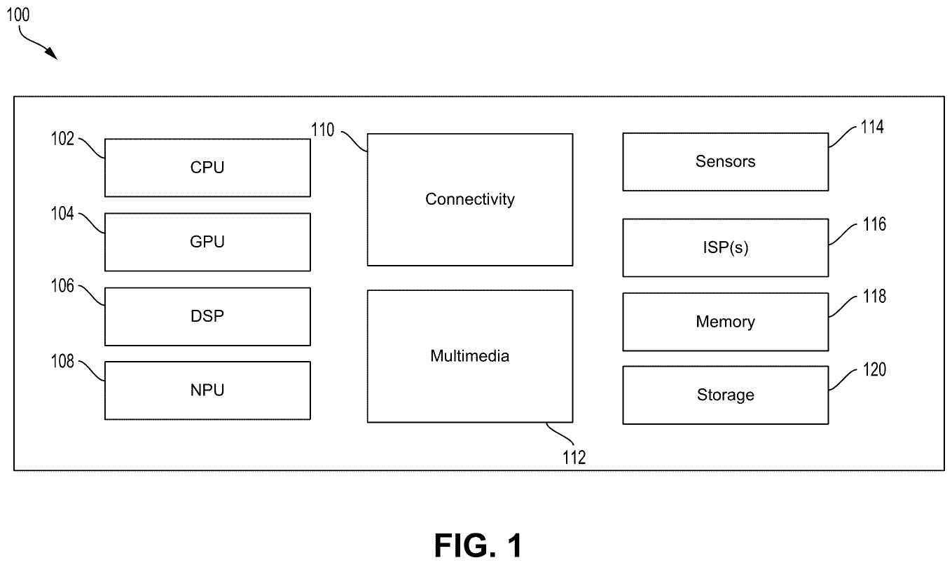

FIG. 1 illustrates an example implementation of a system-on-a-chip (SOC) 100, which may include a central processing unit (CPU) 102 or a multi-core CPU, configured to perform one or more of the functions described herein. Parameters or variables (e.g., neural signals and synaptic weights), system parameters associated with a computational device (e.g., neural network with weights), delays, frequency bin information, task information, among other information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a memory block 118, and/or may be distributed across multiple blocks. Instructions executed at the CPU 102 may be loaded from a program memory associated with the CPU 102 or may be loaded from a memory block 118.

The SOC 100 may also include additional processing blocks tailored to specific functions, such as a GPU 104, a DSP 106, a connectivity block 110, which may include fifth generation (5G) connectivity, fourth generation long term evolution (4G LTE) connectivity, Wi-Fi connectivity, USB connectivity, Bluetooth connectivity, and the like, and a multimedia processor 112 that may, for example, detect and recognize gestures. In some implementations, the NPU is implemented in the CPU 102, DSP 106, and/or GPU 104. The SOC 100 may also include a sensor processor 114, image signal processors (ISPs) 116, and/or storage 120.

The SOC 100 may be based on an ARM instruction set. In an aspect of the present disclosure, the instructions loaded into the CPU 102 may comprise code to search for a stored multiplication result in a lookup table (LUT) corresponding to a multiplication product of an input value and a filter weight. The instructions loaded into the CPU 102 may also comprise code to disable a multiplier during a multiplication operation of the multiplication product when a lookup table hit of the multiplication product is detected. In addition, the instructions loaded into the CPU 102 may comprise code to store a computed multiplication product of the input value and the filter weight when a lookup table miss of the multiplication product is detected.

SOC 100 can be part of a computing device or multiple computing devices. In some examples, SOC 100 can be part of an electronic device (or devices) such as a camera system (e.g., a digital camera, an IP camera, a video camera, a security camera, etc.), a telephone system (e.g., a smartphone, a cellular telephone, a conferencing system, etc.), a desktop computer, an XR device (e.g., a head-mounted display, etc.), a smart wearable device (e.g., a smart watch, smart glasses, etc.), a laptop or notebook computer, a tablet computer, a set-top box, a television, a display device, a system-on-chip (SoC), a digital media player, a gaming console, a video streaming device, a server, a drone, a computer in a car, an Internet-of-Things (IoT) device, or any other suitable electronic device(s).

In some implementations, the CPU 102, the GPU 104, the DSP 106, the NPU 108, the connectivity block 110, the multimedia processor 112, the one or more sensors 114, the ISPs 116, the memory block 118 and/or the storage 120 can be part of the same computing device. For example, in some cases, the CPU 102, the GPU 104, the DSP 106, the NPU 108, the connectivity block 110, the multimedia processor 112, the one or more sensors 114, the ISPs 116, the memory block 118 and/or the storage 120 can be integrated into a smartphone, laptop, tablet computer, smart wearable device, video gaming system, server, and/or any other computing device. In other implementations, the CPU 102, the GPU 104, the DSP 106, the NPU 108, the connectivity block 110, the multimedia processor 112, the one or more sensors 114, the ISPs 116, the memory block 118 and/or the storage 120 can be part of two or more separate computing devices.

Machine learning (ML) can be considered a subset of artificial intelligence (AI). ML systems can include algorithms and statistical models that computer systems can use to perform various tasks by relying on patterns and inference, without the use of explicit instructions. One example of a ML system is a neural network (also referred to as an artificial neural network), which may include an interconnected group of artificial neurons (e.g., neuron models). Neural networks may be used for various applications and/or devices, such as image and/or video coding, image analysis and/or computer vision applications, Internet Protocol (IP) cameras, Internet of Things (IoT) devices, autonomous vehicles, service robots, among others.

Individual nodes in a neural network may emulate biological neurons by taking input data and performing simple operations on the data. The results of the simple operations performed on the input data are selectively passed on to other neurons. Weight values are associated with each vector and node in the network, and these values constrain how input data is related to output data. For example, the input data of each node may be multiplied by a corresponding weight value, and the products may be summed. The sum of the products may be adjusted by an optional bias, and an activation function may be applied to the result, yielding the node's output signal or “output activation” (sometimes referred to as a feature map or an activation map). The weight values may initially be determined by an iterative flow of training data through the network (e.g., weight values are established during a training phase in which the network learns how to identify particular classes by their typical input data characteristics).

Different types of neural networks exist, such as convolutional neural networks (CNNs), recurrent neural networks (RNNs), generative adversarial networks (GANs), multilayer perceptron (MLP) neural networks, transformer neural networks, among others. For instance, convolutional neural networks (CNNs) are a type of feed-forward artificial neural network. Convolutional neural networks may include collections of artificial neurons that each have a receptive field (e.g., a spatially localized region of an input space) and that collectively tile an input space. RNNs work on the principle of saving the output of a layer and feeding this output back to the input to help in predicting an outcome of the layer. A GAN is a form of generative neural network that can learn patterns in input data so that the neural network model can generate new synthetic outputs that reasonably could have been from the original dataset. A GAN can include two neural networks that operate together, including a generative neural network that generates a synthesized output and a discriminative neural network that evaluates the output for authenticity. In MLP neural networks, data may be fed into an input layer, and one or more hidden layers provide levels of abstraction to the data. Predictions may then be made on an output layer based on the abstracted data.

Deep learning (DL) is one example of a machine learning technique and can be considered a subset of ML. Many DL approaches are based on a neural network, such as an RNN or a CNN, and utilize multiple layers. The use of multiple layers in deep neural networks can permit progressively higher-level features to be extracted from a given input of raw data. For example, the output of a first layer of artificial neurons becomes an input to a second layer of artificial neurons, the output of a second layer of artificial neurons becomes an input to a third layer of artificial neurons, and so on. Layers that are located between the input and output of the overall deep neural network are often referred to as hidden layers. The hidden layers learn (e.g., are trained) to transform an intermediate input from a preceding layer into a slightly more abstract and composite representation that can be provided to a subsequent layer, until a final or desired representation is obtained as the final output of the deep neural network.

As noted above, a neural network is an example of a machine learning system, and can include an input layer, one or more hidden layers, and an output layer. Data is provided from input nodes of the input layer, processing is performed by hidden nodes of the one or more hidden layers, and an output is produced through output nodes of the output layer. Deep learning networks typically include multiple hidden layers. Each layer of the neural network can include feature maps or activation maps that can include artificial neurons (or nodes). A feature map can include a filter, a kernel, or the like. The nodes can include one or more weights used to indicate an importance of the nodes of one or more of the layers. In some cases, a deep learning network can have a series of many hidden layers, with early layers being used to determine simple and low-level characteristics of an input, and later layers building up a hierarchy of more complex and abstract characteristics.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases. Deep learning architectures may perform especially well when applied to problems that have a natural hierarchical structure. For example, the classification of motorized vehicles may benefit from first learning to recognize wheels, windshields, and other features. These features may be combined at higher layers in different ways to recognize cars, trucks, and airplanes.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

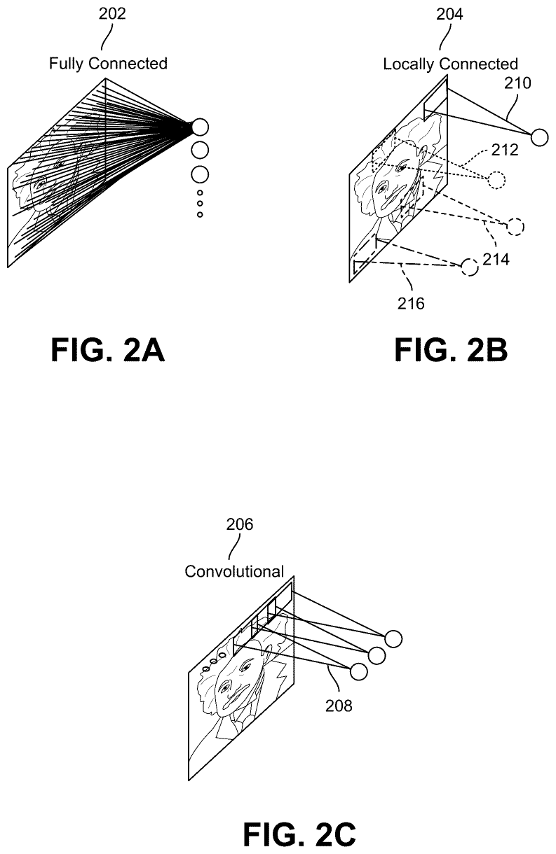

The connections between layers of a neural network may be fully connected or locally connected. FIG. 2A illustrates an example of a fully connected neural network 202. In a fully connected neural network 202, a neuron in a first hidden layer may communicate its output to every neuron in a second hidden layer, so that each neuron in the second layer will receive input from every neuron in the first layer. FIG. 2B illustrates an example of a locally connected neural network 204. In a locally connected neural network 204, a neuron in a first hidden layer may be connected to a limited number of neurons in a second hidden layer. More generally, a locally connected layer of the locally connected neural network 204 may be configured so that each neuron in a layer will have the same or a similar connectivity pattern, but with connections strengths that may have different values (e.g., 210, 212, 214, and 216). The locally connected connectivity pattern may give rise to spatially distinct receptive fields in a higher layer, because the higher layer neurons in a given region may receive inputs that are tuned through training to the properties of a restricted portion of the total input to the network.

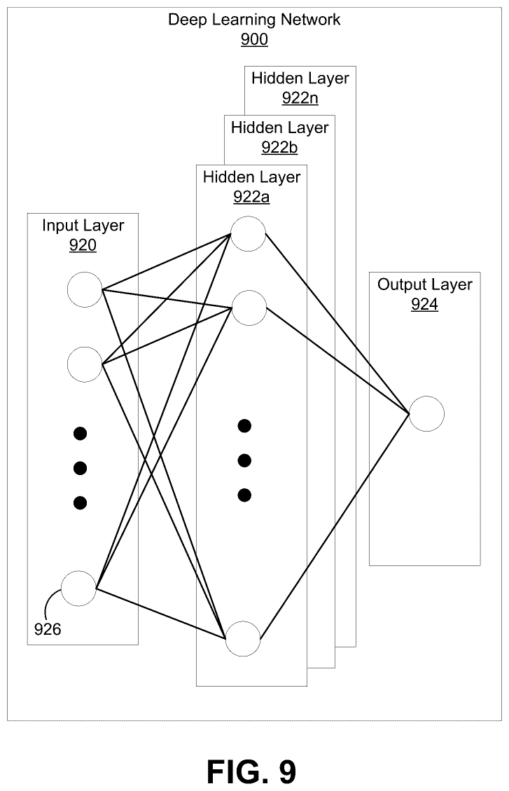

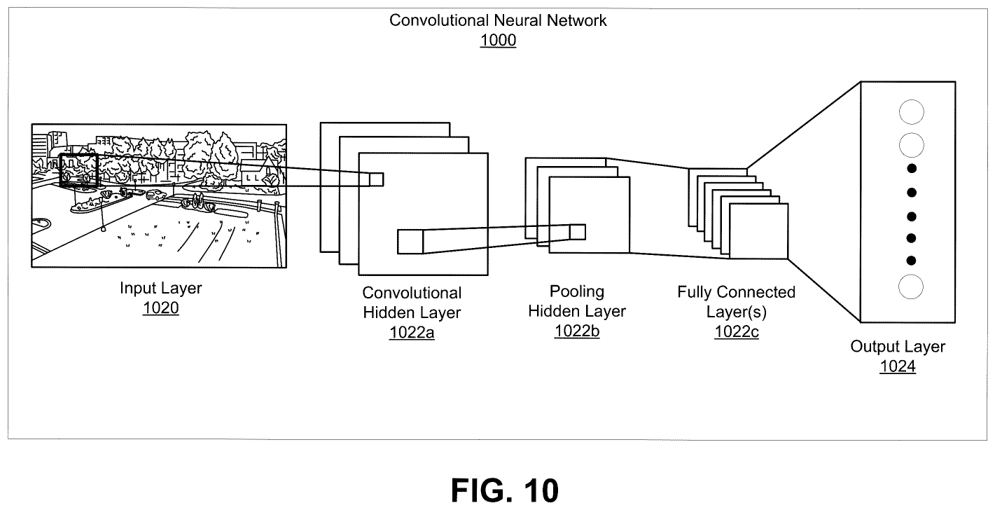

One example of a locally connected neural network is a convolutional neural network. FIG. 2C illustrates an example of a convolutional neural network 206. The convolutional neural network 206 may be configured such that the connection strengths associated with the inputs for each neuron in the second layer are shared (e.g., 208). Convolutional neural networks may be well suited to problems in which the spatial location of inputs is meaningful. An illustrative example of a deep learning network is described in greater depth with respect to the example block diagram of FIG. 9. Illustrative examples of convolutional neural networks are described in greater depth with respect to the example block diagrams of FIGS. 10-12.

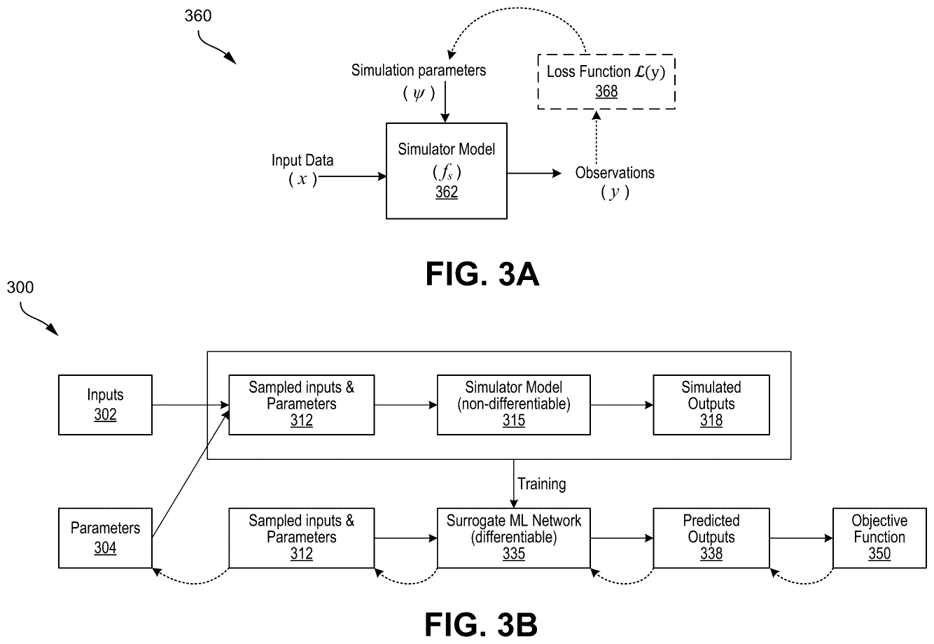

As mentioned previously, the systems and techniques described herein can be used to perform simulation processing for inverse problems, including inverse problems associated with optimizing simulation parameters of black-box and/or non-differentiable (e.g., stochastic) simulators. FIG. 3A is a diagram illustrating an example of a forward process 360 associated with a simulator model ƒₛ 362. In some examples, the simulator model ƒₛ 362 may be a black-box simulator configured to implement the forward process 360 between input data (x) and a set of corresponding observations (y). In some aspects, the simulator model 362 can be a black-box simulator that implements and/or is associated with a forward simulator model ƒₛ: (ψ, x)=→y. The forward simulator model ƒₛ can map continuous simulation parameters ψ and input data x to a simulator output comprising the observations y.

Performing simulation parameter optimizations for the simulator model ƒₛ 362 (e.g., optimizing the simulation parameters w/used by the simulator model ƒₛ 362) and the associated simulation of the forward process 360 can be beneficial for improving the accuracy and/or computational efficiency of the simulation. In some examples, an inverse problem can be formulated where the goal (e.g., objective or objective function) of the inverse problem corresponds to optimizing the simulation parameters ψ of the black-box simulator model ƒₛ 362 to minimize an observation loss associated with the output observations y.

For example, the inverse problem can correspond to optimizing the simulation parameters ψ of the black-box simulator model ƒₛ 362 under a configured loss function [symbol] (y) 368 (e.g., the observation loss minimized by solving the inverse problem is the loss function [symbol] (y) 368). As noted previously, inverse problems can be associated with deducing unknown properties or parameters of a system that have a causal effect on observed data of the system.

In the case of black-box simulator optimization (e.g., simulation parameter optimization for black-box simulators), the loss function [symbol] (y) 368 corresponds to the observed data for the inverse problem (e.g., as the loss function [symbol] (y) 368 is a function of the simulator model's output of the observations y), and the optimal values of the continuous simulation parameters ψ of the black-box simulator model ƒₛ 362 correspond to the unknown properties or parameters that are solved for in the inverse problem. The causal effect associated with the inverse problem formulation is the minimizing of the loss function [symbol] (y) 368.

In an illustrative example, the black-box simulator model ƒₛ 362 may be a particle physics simulator for simulating the detection of muons y, given properties of particles entering the detector x and detector settings ψ. Optimizing the example particle physics black-box simulator model ƒₛ 362 can correspond to minimizing the number of muon detection events (e.g., considered noise). The optimization can be an inverse problem, based on the number of muon detection events being the observable effect, and the values of the optimal detector settings y being a non-observable (e.g., non-directly observable) causal effect or factor in the number of muon detection events.

In some examples, black-box simulator model optimization (e.g., optimization of the simulation parameters ψ of the black-box simulator model ƒₛ 362) can utilize one or more gradient-based optimization techniques. For example, in gradient-based optimization techniques, gradients (e.g., vectors of partial derivatives) of the objective function can be determined and used to guide the search for the optimal solution. Applying gradient-based optimization techniques directly to black-box simulator model optimization may require that the black-box simulator model (e.g., black-box simulator model ƒₛ 362) is differentiable or can be approximated as differentiable.

As noted previously, many black-box simulator models are non-differentiable, are stochastic (e.g., and therefore non-differentiable), and/or are complete black-boxes with hidden internal logic that cannot be examined and approximated as differentiable. In some cases, non-differentiable black-box simulator optimization may be performed based on numerical differentiation, evolutionary strategies or techniques, or Bayesian optimization, etc.

In some examples, gradient-based optimization can be performed for the simulation parameters of non-differentiable black-box simulators based on using a differentiable machine learning surrogate model that is trained to iteratively approximate the simulator in local neighborhoods of the parameter space. After training the differentiable surrogate model to approximate the black-box simulator (which is non-differentiable), the gradients of the differentiable surrogate model can be calculated and used for the gradient-based optimization. The gradient-based optimization may be performed indirectly for the non-differentiable black-box simulator, based on directly performing gradient-based optimization on the differentiable surrogate model trained to approximate the black-box simulator.

For example, FIG. 3B is a diagram illustrating an example of a training process 300 for simulator model 315 and a surrogate machine learning network 335, in accordance with some examples. In some cases, the simulator model 315 can be a non-differentiable black-box simulator, and can be the same as or similar to the non-differentiable black-box simulator model ƒₛ 362 of FIG. 3A. The surrogate machine learning (ML) network 335 may be a neural network or other machine learning network that is trained to approximate the simulator model 315. The surrogate ML network 335 can be trained to iteratively approximate the simulator model 315 within a configured local neighborhood of the parameter space (e.g., a local neighborhood or subset of the parameter space corresponding to the simulation parameters ψ of the black-box simulator model 315). In some examples, the surrogate ML network 335 can also be referred to as a local surrogate.

Based on the black-box simulator model 315 being non-differentiable, simulator gradients cannot be directly determined because the gradients are calculated as vectors of partial derivatives. In some aspects, the local surrogate 335 can be used to approximate the gradients of the non-differentiable simulator model 315. The gradient approximation provided by the calculated gradients of the differentiable local surrogate 335 can then be used to perform gradient-based optimization of one or more simulation parameters ψ of the black-box simulator model 315.

In some aspects, the black-box simulator model 315 and the surrogate ML network 335 can be trained based on a shared set of inputs 302 (e.g., which may be the same as or similar to the input data x of FIG. 3A) and parameters 304 of the simulator (e.g., which may be the same as or similar to the simulation parameters ψ of FIG. 3A).

In some cases, the inputs 302 comprise one or more distributions of input data and the parameters 304 comprise one or more distributions of continuous simulation parameters. A set of sampled inputs and parameters 312 can be obtained based on performing a sampling process to obtain a subset of input data sampled from the input distribution 302 and a subset of simulation parameters sampled from the simulation parameter distribution 304. The set of sampled inputs and parameters 312 can include the subset of sampled input data and the subset of sampled parameters, and can be processed by the non-differentiable simulator model to determine the simulated outputs 318. For example, the set of sampled inputs and parameters 312 can be used for the forward pass through the non-differentiable black-box simulator model 315 to generate the simulated outputs 318 (e.g., observations y). The simulated outputs 318 can include respective output values determined by the black-box simulator model 315 for each combination of input and simulation parameters included in the set of sampled inputs and parameters 312.

The surrogate ML network 335 can be trained using the same set of sampled inputs and parameters 312 as training data, and using the respective output values determined by the black-box simulator model 315 as ground truth information for supervised learning. For example, each combination of input and simulation parameters from the set of sampled inputs and parameters 312 can be labeled and/or associated with the corresponding output value(s) determined by the forward pass of the black-box simulator model. Each combination of input and simulation parameters from the set of sampled inputs and parameters 312 can be provided to and processed by the surrogate ML network 335 to generate a corresponding one or more predicted outputs 338. Supervised learning can be performed to train the surrogate ML network 335 to minimize an objective function 350 (e.g., a loss function, a difference, etc.) between the predicted output 338 of the surrogate ML network 335 and the ground-truth simulated output 318 of the simulator model 315 determined for the same combination of input and simulation parameters from the set of sampled inputs and parameters 312.

For example, to train the differentiable surrogate ML network 335 to approximate the non-differentiable simulator model 315, the approximated surrogate observations y 338 should correspond to (e.g., be similar to) the ground-truth simulator observations y 318. In some aspects, the approximated surrogate observations y 338 can be evaluated against an objective function 350. The objective function 350 can be a function of the approximated surrogate observations 338 (e.g., an objective function R (y), etc.), and can be evaluated to quantify how well the surrogate model 335 and surrogate outputs 338 approximate the true simulator outputs 318. The objective function 350 can be used to guide the training of the surrogate model 335, for example based on training the surrogate model 335 to minimize the discrepancy or difference between the approximated surrogate outputs 338 and the ground-truth outputs 318 of the simulator model 315.

The arrows represented with a solid line in FIG. 3B can correspond to forward propagation for the simulation and surrogate training process 300. The curved arrows represented with a dashed line in FIG. 3B can correspond to error backpropagation for the simulation and surrogate training process 300. In one illustrative example, the surrogate model 335 can be trained and used to optimize the parameters 304 of a stochastic black-box simulator 315 using stochastic gradient descent and/or various other gradient-based optimization techniques.

For example, after using the objective function 350 to evaluate the approximate surrogate outputs 338, the gradients of the objective function 350 can be calculated with respect to the simulation parameters 304, and backpropagated to update (e.g., optimize) the simulation parameters 304 of the stochastic black-box simulator 315 using stochastic gradient descent. The stochastic gradient descent for optimizing the simulation parameters 304 for the non-differentiable, stochastic black-box simulator 315 can be performed based on the gradients of the differentiable surrogate model 335 (e.g., gradients of the objective function 350 for the local surrogate 335 taken with respect to the simulation parameters 304, computed using backpropagation as represented by the dashed arrows of FIG. 3B).

The gradient can subsequently be backpropagated from the approximate surrogate outputs 338 to the differentiable surrogate ML network 335. In some aspects, the gradient is backpropagated from the outputs 338 to the surrogate ML network 335 parameters, based on determining a partial derivative of the of the gradient or objective function 350 with respect to the simulation parameters 304. The gradient can be backpropagated from the surrogate model 335 to the sampled inputs and parameters 312, although in at least some examples the sampled inputs and parameters 312 are not updated during surrogate 335 training or the associated gradient backpropagation.

The gradient can subsequently be backpropagated to the original parameter space 304 of the simulation parameters ¿ associated with the non-differentiable black-box simulator model 315 that the surrogate ML model 335 is being trained to approximate. For example, the simulation parameters dt for the current time step/can be updated based on the backpropagated gradients or gradient information estimated by the surrogate ML model 335, to thereby generate the updated simulation parameters ψₜ₊₁ for the next time step t+1.

Learned differentiable surrogate models can approximate the stochastic behavior of a non-differentiable simulator, and can be used for direct gradient-based optimization of an objective by parameterizing the surrogate model with the relevant simulation parameters of the simulator. In some cases, training the surrogate model over the complete simulation parameter space of the simulator may be computationally expensive and may increase with the dimensionality of the simulation parameter space (e.g., it may be more computationally complex to train a surrogate model for higher-dimensional simulation parameter spaces).

For example, to train the surrogate model to approximate the simulator, a plurality of simulator calls are made (e.g., the simulator model 315 runs or is evaluated on the sampled inputs 312 to generate output data that can be used for training the surrogate 335). In some cases, a goal of the gradient-based optimization may be to optimize the simulator and/or simulation parameters to use fewer simulator calls during inference. If training the surrogate model utilizes a relatively large number of simulator calls to obtain the training data and/or to obtain simulator outputs that can be evaluated against the surrogate approximation by the training loss function, the benefits of performing the surrogate-based optimization may be outweighed by the additional simulator calls and model evaluations that are performed during the training of the surrogate model. Systems and techniques that can be used to perform surrogate training to minimize the number of simulator calls and/or forward model evaluations associated with downstream inverse problem optimizations may be beneficial.

In simulator optimization techniques that utilize a learned differentiable surrogate model to approximate a non-differentiable simulator, a one-to-one correspondence may also exist between the learned surrogate and the simulator. For example, a separate instance of the differentiable surrogate model may be trained for each particular simulator that is to be approximated and optimized (e.g., each inverse problem optimization for the simulation parameters of a different black-box non-differentiable simulator may be started ab initio). Techniques based on training a learned differentiable surrogate model for each black-box simulator can scale poorly and inefficiently when such techniques are used to solve multiple related inverse problems. Multiple related inverse problems may also be referred to as a family of inverse problems, and in some examples can correspond to optimizing the simulation parameters of a black-box simulator where the simulator is evaluated under many different potential input distributions or properties (e.g., each different potential input distribution or input properties may correspond to a respective inverse problem included in the family of multiple related inverse problems). In the previous example of the particle physics black-box simulator, a single inverse problem was formulated corresponding to optimizing the simulation properties (e.g., simulation parameters ¿/corresponding to the detector settings for the particle physics simulation) for simulating the detection of muons y, given the properties x of particles entering the detector and the detector settings. A family of multiple related inverse problems associated with optimizing the particle physics black-box simulation parameters can correspond to solving the particle physics inverse problem to optimize the detector settings ψ (e.g., to optimize the simulation parameters) for many different potential input distributions over muon properties x.

In one illustrative example, the computational complexity associated with surrogate training for a family of 10 related inverse problems may be the same as that associated with surrogate training for a family of 10 entirely unrelated inverse problems, based on each inverse problem optimization utilizing a surrogate model that is trained from scratch (e.g., ab initio). Systems and techniques that can be used to efficiently solve multiple related inverse problems associated with black-box simulation parameter optimization can be beneficial. Systems and techniques that can solve multiple related inverse problems using a smaller number of simulator calls and forward model evaluations and/or using a smaller number of surrogate model instances may also be beneficial.

The systems and techniques described herein can be used to perform simulation processing for inverse problems (e.g., optimization of simulation parameters for non-differentiable black-box simulators, etc.) and/or classes or families of related inverse problems, while minimizing the number of calls to the simulator and forward model evaluations that are performed. For example, the systems and techniques can be used to solve one or more related inverse problems associated with optimizing the simulation parameters of a black-box non-differentiable simulator. Reinforcement learning (RL) machine learning networks and techniques can be used to train an active learning policy for the training of a differentiable surrogate model to approximate the black-box non-differentiable simulator.

For example, the active learning policy can be used to guide the training of a surrogate model that can be used to generate differentiable samples approximating the output of the non-differentiable black-box simulator. In some aspects, the surrogate can be a learned differentiable model that can be learned for a single black-box simulator inverse problem (e.g., optimization of a simulation parameters associated with a single black-box simulator). In some cases, the surrogate is a learned differentiable model that can be used to solve a family or class of multiple related black-box simulator inverse problems (e.g., optimizations of simulation parameters associated with multiple simulators or simulator configurations, etc.). The gradients of the learned differentiable surrogate can then be determined and used to optimize the simulation parameters of the non-differentiable simulator through gradient descent. The active learning policy can be used to guide the training of the differentiable surrogate, and can be configured (e.g., using reinforcement learning for the policy) to minimize or reduce the number of simulator calls and forward model evaluations used for training the differentiable surrogate.

In some aspects, the systems and techniques described herein can be used to optimize the simulation parameters v of a stochastic black-box and non-differentiable simulator by performing stochastic gradient descent. As noted previously, black-box simulators may be unsuitable for automatic differentiation techniques, and are often non-differentiable by analytical techniques. In one illustrative example, a surrogate machine learning network (e.g., a surrogate neural network) can be trained to locally (e.g., within the simulation parameter space ψ of the simulator) approximate the simulator, and gradients of the local surrogate(s) can subsequently be used to perform the optimization over ψ.

The stochastic black-box and non-differentiable simulator can be represented by:

$$y = {f}_{s} ( ψ , x ) \qquad Eq . ( 1 )$$

The function ƒₛ in Eq. (1) represents the simulator, which can be the same as or similar to the simulator 362 of FIG. 3A and/or the simulator 315 of FIG. 3B, etc. The terms ψ and x represent the inputs to the simulator ƒₛ. For example, ψ represents the simulation parameters that parameterize the function ƒₛ in Eq. (1), and may be the same as or similar to the simulation parameters ψ of FIG. 3A and/or the simulation parameter distribution 304 (and corresponding sampled parameters 312) of FIG. 3B. The term x in Eq. (1) can represent input data to the simulator, and can be the same as or similar to the input data x of FIG. 3A, the input distribution 302 of FIG. 3B, and/or the sampled inputs 312 sampled from the distribution 302 of FIG. 3B, etc.

In some aspects, the stochastic simulator can be represented using Eq. (1), where y˜p(y|ψ, x) is a random variable and x˜q(x) is a stochastic input. The simulator ƒₛ can be optimized by minimizing an expected observation loss [symbol] as a function of the simulation parameters. In some aspects, the expected observation loss [symbol] can be the same as or similar to the loss function 368 of FIG. 3A.

The functional form of the black-box simulator may be generally unknown (e.g., based on the black-box nature of the simulator), and the expected observation loss [symbol] cannot be evaluated directly. In some cases, the expected observation loss [symbol] can be estimated using N Monte Carlo samples:

$${ψ}^{*} = arg {min}_{ψ} [ ℒ ( y ) ] = {arg min}_{ψ} \int ℒ ( y ) p ( y \vert ψ , x ) q ( x ) dx dy \qquad Eq . ( 2 )$$

$$\approx {arg min}_{ψ} \frac{1}{N} {\sum }_{i = 1}^{N} ℒ ( {f}_{s} ( ψ , {x}_{i} ) ) \qquad Eq . ( 3 )$$

A neural network-based surrogate model can be a learned differentiable surrogate trained to approximate the stochastic simulator ƒₛ of Eq. (1). In some aspects, the neural network surrogate can be represented as:

$${f}_{ϕ} \text{:} ( ψ , x , z ) \to y \qquad Eq . ( 4 )$$

The term z represents a randomly sampled latent variable that can be used to represent the stochasticity of the simulator ƒₛ of Eq. (1). The neural network surrogate ƒ_{ϕ} of Eq. (4) can be trained on data generated using the stochastic simulator ƒₛ of Eq. (1). For example, the neural network surrogate ƒ_{ϕ} can be trained using the simulator ƒₛ output data (e.g., observations) y of Eq. (1).

Optimization of the simulation parameters ψ can be performed following (e.g., based on) gradients of the learned differentiable neural network surrogate ƒ_{ϕ}. For example, the gradients of the surrogate ƒ_{ϕ} can be determined with respect to the simulation parameters ψ, based on:

$${∇}_{ψ} [ ℒ ( y ) ] \approx \frac{1}{N} {\sum }_{i = 1}^{N} {∇}_{ψ} ℒ ( {f}_{ϕ} ( ψ , {x}_{i} , {z}_{i} ) ) \qquad Eq . ( 5 )$$

In some aspects, the systems and techniques can perform an iterative optimization of the simulation parameters ψ based on the surrogate gradients determined using Eq. (5). For example, at each point or iteration within the optimization, a subset of sampled simulation parameter values ψⱼ can be obtained by performing sampling with the simulation parameter space of the current ψ.

For example, the optimization can be performed using the simulation parameter values ψⱼ sampled from a fixed-size box or local window

$${U}_{ϵ}^{ψ}$$

within the simulation parameter space around the current ψ. The parameter ϵ can be indicative of and/or used to configure the sizes of the box or local window

$${U}_{ϵ}^{ψ}$$

within which the sampling is performed.

In some aspects, the sampled values v, can be obtained from the simulation parameter space around the current ψ and used to train the neural network surrogate ƒ_{ϕ}. For example, the systems and techniques can sample ψⱼ values from the sampling window

$${U}_{ϵ}^{ψ} ,$$

with sides length 2ϵ, around the current ψ. The sampled values ψⱼ can be used as the simulation parameters for the current iteration of the iterative optimization (e.g., the sampled values ψⱼ can correspond to the simulation parameters of FIG. 3A, and/or can correspond to the sampled simulation parameters included in the sampled data 312 of FIG. 3B, etc.).

Each iteration can additionally include obtaining xᵢ samples of input data, sampled from the input distribution x associated with the simulator (e.g., the input distribution x of Eq. (1), the input distribution 302 of FIG. 3B, etc.).

The xᵢ input data sampled from the input distribution and the ψⱼ simulation parameter values sampled from the simulation parameter space around the current ψ for the simulator can be the same as or similar to the sampled inputs and parameters 312 associated with the simulator 315 of FIG. 3B, and may be used as inputs for running the forward process of the simulator to generate a corresponding set of output samples y (e.g., the output samples y obtained by calculating Eq. (1) using the xᵢ input data sampled from the input distribution and the w; simulation parameter values sampled from the current ψ for the simulator).

The forward samples y can be the same as or similar to the simulated output 318 of FIG. 3B. In some aspects, the forward samples y can be stored in a history H for the iterative optimization process. In some cases, the neural network surrogate model ƒ_{ϕ} can be trained with training data obtained based on sampling from the forward sampling history H that is accumulated for the simulator ƒₛ. For example, the training data can be obtained from the forward sampling history H using a trust-region-based technique configured to obtain all samples (ψⱼ, xᵢ, yⱼᵢ) for which ψⱼ lies inside the box (e.g., trust region)

$${U}_{ϵ}^{ψ}$$

centered on the current simulation parameter value ψ.

In some aspects, a “simulator call” can refer to obtaining training data samples from the trust-region or sampling window centered on the current simulation parameter value ψ of the simulator. For example, each simulator call can return the set of all samples (ψⱼ, xᵢ, yⱼᵢ) for which ψⱼ lies inside the box (e.g., trust region)

$${U}_{ϵ}^{ψ}$$

centered on the current simulation parameter value ψ.

As noted previously, it can be beneficial to reduce the number of simulator calls performed during optimization processing for the simulation parameters of a stochastic black-box simulator (e.g., gradient-based optimization using stochastic gradient descent following the gradients of the learned differentiable neural network surrogate trained to approximate the simulator). However, reducing the number of simulator calls to zero may correspond to decreased accuracy, as the surrogate model is typically implemented to approximate the simulator outputs within a local neighborhood and is not configured or trained to fully replace the black-box simulator. For example, the surrogate-based optimization techniques for solving inverse problems for black-box simulators may utilize both the non-differentiable simulator and the differentiable surrogate model during training, and may also utilize both the non-differentiable simulator and the differentiable learned surrogate model during inference.

In some examples, the systems and techniques can utilize reinforcement learning (RL) techniques and/or one or more RL-based machine learning networks to continuously or periodically evaluate the learned surrogate model against the black-box simulator during inference. For example, the learned differentiable surrogate may not always provide useful gradients (e.g., surrogate gradients determined using Eq. (5)) for optimizing the simulation parameters, and the RL-based techniques can be used to provide a policy network that evaluates the surrogate gradients of Eq. (5) prior to their use in optimizing the simulation parameters.

In some cases, the accuracy of the approximations generated by the learned differentiable surrogate may drift or decrease relative to the ground-truth outputs that would be generated by the simulator given the same inputs. In examples where a goal of the surrogate-based optimization is to reduce the number of simulator calls and forward model evaluations that are performed, the ground truth simulator outputs may not be known or available to the policy network. In some aspects, the systems and techniques can train the policy network to determine when the surrogate approximation of the simulator has failed or decreased in accuracy (e.g., decreased below an accuracy threshold, a confidence threshold, etc.). Based on the policy network determining that the surrogate approximation of the simulator has failed or decreased in one or more of accuracy or confidence, the systems and techniques can perform a fallback to the simulator. For example, using the same inputs that were used to generate the surrogate approximation that was rejected by the policy network, the systems and techniques can perform a simulator call and evaluate the same inputs through a full forward model evaluation of the simulator. The generated simulator outputs can subsequently be used to perform re-training and/or fine-tuning of the surrogate, where the re-training or fine-tuning can be performed during inference processing.

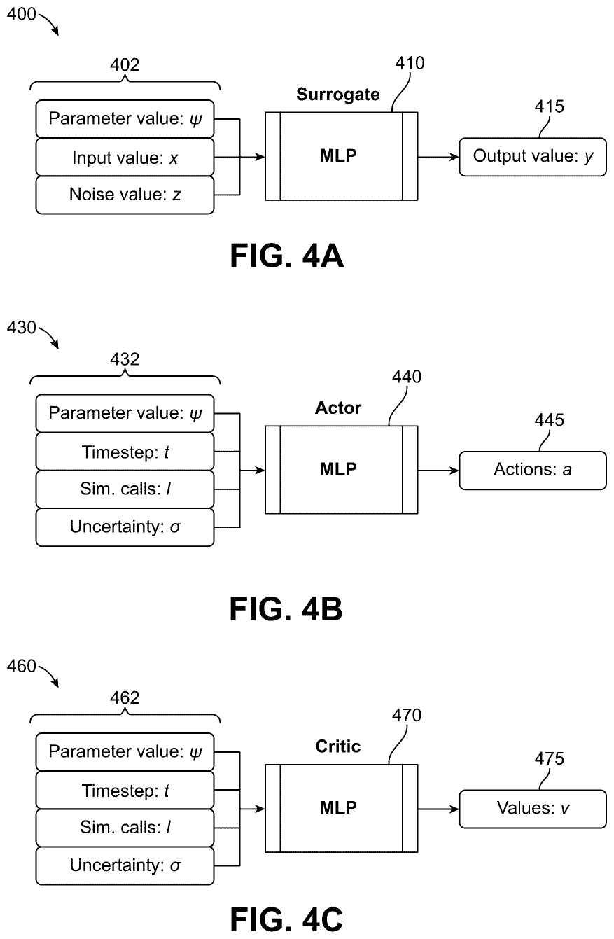

FIG. 4A is a diagram illustrating an example of a surrogate machine learning network 400, in accordance with some examples. In some aspects, the surrogate machine learning network 400 of FIG. 4A can be implemented as a surrogate neural network that is trained to approximate a stochastic and/or non-differentiable black-box simulator. The surrogate machine learning network 400 may also be referred to as “the surrogate model,” “the surrogate neural network,” and/or “the surrogate,” etc. The surrogate machine learning network 400 can be a learned, differentiable machine learning model (e.g., neural network) trained to approximate a non-differentiable simulator. In some examples, the surrogate model 400 of FIG. 4A can be the same as or similar to the surrogate model 335 of FIG. 3B, etc.

The surrogate model 400 can be implemented as a multi-layer perceptron (MLP) neural network 410. In some aspects, the surrogate model 400 can utilize a rectified linear unit (ReLU) activation function. For example, the surrogate model 400 can be implemented as a ReLU MLP neural network 410, utilizing a ReLU activation function ƒ(x)=max(0, x). In one illustrative example, the surrogate model 400 can be a ReLU MLP that includes an input layer, two hidden layers of 256 neurons, and an output layer. The use of the ReLU activation function for the surrogate model 400 can be used to introduce non-linearity to the surrogate and can provide efficient gradient propagation for the stochastic gradient descent utilized to optimize the simulation parameters of the corresponding black-box simulator approximated by the surrogate model 400. The ReLU activation function can be applied at each node of the hidden layers of the surrogate model 400 to transform the weighted inputs from the nodes of the previous layer before passing the transformed weighted inputs to the nodes of the next layer.

In some aspects, the surrogate model 400 can receive a set of inputs 402 that includes the current simulation parameter value(s) ψ, the input values x, and a noise value z. In some examples, the surrogate model 400 can be the same as the surrogate ƒ_{ϕ} of Eq. (4), and the inputs 402 can be the same as the respective values in Eq. (4). For example, the inputs 402 to the surrogate model 400 can include a noise value z that is the same as the randomly sampled latent variable z used in Eq. (4) to represent the stochasticity of the simulator that is approximated by the surrogate model.

In some examples, the inputs 402 to the surrogate model 400 can include the noise value z, where z is sampled from a 100-dimensional diagonal unit normal distribution. The surrogate 400 can be trained to generate output values 415 y that are the same as or similar to the surrogate outputs of Eq. (4), and/or the surrogate outputs 338 of FIG. 3B, etc.

In some cases, the surrogate neural network (e.g., MLP, ReLU MLP, etc.) models can be trained on data generated from the black-box simulator ƒₛ. In some cases, M simulation parameter values ψⱼ can be sampled from within the local window (e.g., trust region)

$${U}_{ϵ}^{ψ}$$

around the current simulation parameter value ψ included in the set of inputs 402 to the surrogate model 400. In some examples, the sampling to obtain the M simulation parameter values ψⱼ can be performed based on a Latin Hypercube sampling algorithm.

For each of the sampled simulation parameter values ψⱼ, the systems and techniques can be configured to sample N=3·10³ x-values (e.g., where the x-values represent a sampled subset or portion of input data sampled from the input distribution x). For a simulation parameter sampling value of M=5, a single “simulator call” can correspond to 1.5·10⁴ function evaluations. For a simulation parameter sampling value of M=16, a single “simulator call” can correspond to 4.8·10⁴ function evaluations.

The surrogate model(s) 400 can be trained using the M values ψⱼ and the Nx-values samples for each of the Mψⱼ. In some aspects, the surrogate models 400 can be trained using Adam optimizer. In one illustrative example, an ensemble of multiple surrogate models 400 can trained on the same data, with each surrogate of the ensemble utilizing the same MLP 410 and/or underlying neural network architecture but configured with a different random seed. In some examples, the systems and techniques can use an ensemble of three surrogate models 400, trained on the same input data 402 and using a different random seed for the ReLU MLP 410 backbone of each of the three surrogate models 400. In some examples, training of the surrogates can be performed using the Adam optimizer for two epochs with a learning rate of 10⁻³ and a batch size of 512.

In some aspects, the surrogate model 400 and/or ensemble of a plurality of surrogate models 400 with different random seeds (e.g., an ensemble of three surrogate models 400, etc.) can be trained based on a loss function corresponding to a mean-squared error (MSE) between the surrogate's predicted output observation y 415 and the simulator ground truth y*=ƒₛ (ψ, x). In some examples, the simulator ground truth y* can be obtained according to Eq. (1) and the inputs 402 to the surrogate model 400.

FIG. 4B is a diagram depicting an example of an actor neural network 430 (e.g., also referred to as the “actor”) that can be included in a reinforcement learning policy network π_{θ}. FIG. 4C is a diagram illustrating an example of a critic neural network 460 (e.g., also referred to as the “critic”) that can be included in the same reinforcement learning policy network π_{θ} as the actor 430 of FIG. 4B.

In some aspects, the actor network 430 can be implemented using an MLP neural network 440, and the critic network 460 can be implemented using an MLP neural network 470. In some cases, the MLP 440 and the MLP 470 can be the same as or similar to one another. In some examples, one or more of the MLP 440 and/or the MLP 470 can be the same as or similar to the surrogate MLP 410 of FIG. 4A.

In some examples, the actor MLP 440 and the critic MLP 470 can be implemented as ReLU MLP neural networks with a single hidden layer of 256 neurons. Both networks can receive as input a tuple ψₜ, t, lₜ, σₜ), where ψₜ is the current simulation parameter value (e.g., at timestep t), lₜ is the number of simulator calls already performed this episode, and σₜ is the standard deviation over average surrogate predictions in the ensemble. For example, the input tuple 432 to the actor MLP 440 can be the same as the input tuple 462 to the critic MLP 470.

The actor MLP 440 can be configured to generate as output a set of one or more actions a 445. The actions a 445 may be determined based on processing the input tuple 432 by the actor MLP 440. The actions a 445 can be generated by the actor MLP 440 to include a single value, indicative of a decision on whether a simulator call should be performed. A decision not to perform a simulator call may correspond to using only the surrogate 410 approximation output 415. A decision to perform a simulator call may correspond to using the simulator to process or evaluate the surrogate inputs 402 to obtain the simulator ground truth y*.

In some examples, the first value output by the actor MLP 440 (e.g., the first value that is always included in the actions a 445, in both the one value configuration and three value configuration for the actions a 445) can be passed through a sigmoid activation and treated as a Bernoulli random variable from which b, a variable representing the decision to perform or not perform a simulator call, is sampled.

In examples where the policy network π_{θ} and the actor MLP 440 output a set of actions a 445 that includes three values, the first of the three action a values can be the same as described above. The second and third values of the three action a values can be indicative of the mean and the standard deviation (respectively) of a lognormal distribution that is used to sample the local window or trust region size parameter ϵ for the current timestep 1. In some cases, the second value of the three action a values 445 can correspond to the mean of the lognormal distribution for sampling the window size ϵ, and the third value of the three action a values 445 can correspond to the standard deviation of the lognormal distribution for sampling the window size ϵ. In some examples, the action a value 445 corresponding to the standard deviation of the lognormal distribution (e.g., the third value) can be processed by a softplus activation to ensure a positive value on the standard deviation.

In some aspects, the actor MLP network 440 can be configured to generate the set of output actions a 445 to include three action values based on a determination to perform resampling of the local window or trust region size parameter ϵ. The actor MLP network 440 can be configured to generate the set of output actions a 445 to include one action value based on a determination to not perform resampling of the local window or trust region size parameter ϵ.

In both examples (e.g., output actions a 445 that include one value, and output actions a 445 that include three values), the first value corresponding to Bernoulli random variable for sample the decision variable b for performing a simulator call can be indicative of the confidence (or lack of confidence) determined by the actor MLP 440 for the current output 415 of the surrogate model 410. In examples where the output actions a 445 of the actor MLP 440 correspond to a sampled decision variable b that indicates a simulator call should be performed, the confidence or accuracy determined by the actor MLP 440 for the surrogate 410 and/or surrogate output 415 is relatively low. The simulator call can be performed and used to obtain ground-truth simulator data y* for re-training and/or fine-tuning the surrogate MLP model 410.

In some aspects, the systems and techniques can be configured to train policies for the actor MLP network 440 to additionally output the information indicative of or associated with the window size parameter ϵ for constructing or determining the trust-region

$${U}_{ϵ}^{ψ} ,$$

which can be used as the data acquisition function for the surrogate models described herein. The window size parameter ϵ parameterizes the data acquisition function for the surrogate, and the policies for generating actions a 445 to include values indicative of the window size parameter ϵ can be trained using active learning and/or learning active learning as a distribution over ϵ is learned.

The critic MLP network 470 can be used to implement a value function critic configured to generate output values v 475 based on the input tuple 462. The output values v 475 can correspond to or indicate a value-function estimate V_{θ}(s), where θ represents policy parameters for the policy network π_{θ}. In some aspects, the value-function estimate V_{θ}(s) 475 determined by the critic MLP network 470 can be used for training of the policy network π_{θ} (e.g., where the policy network includes the actor MLP network 440 and the critic MLP network 470). In one illustrative example, training of the policy network π_{θ} can be performed using proximal policy optimization (PPO) techniques and/or other policy gradient methods for training an agent's policy network. For example, the value-function estimate V_{θ}(s) 475 determined by the critic MLP network 470 can be used for determining advantage estimated in PPO-based training of the policy network π_{θ}. In some cases, the RL-based rewards used in the PPO-based training of the policy network π_{θ} may have unity order of magnitude, and return values are expected to be anywhere in [−T, 0]. To prevent scaling issues, in some aspects the critic MLP network 470 output values 475 can be multiplied by T before being used for advantage estimation during the PPO-based training of the policy network π_{θ}.

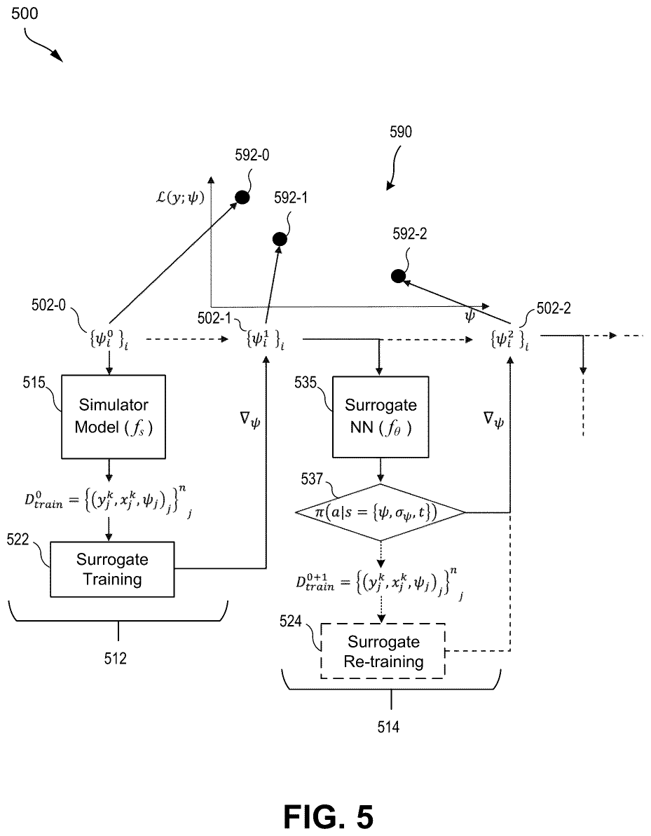

FIG. 5 is a diagram illustrating an example of a reinforcement learning (RL)-based process 500 for training one or more agents of a policy network to minimize the number of calls made to a simulator, in accordance with some examples. In some aspects, the RL-based process 500 of FIG. 5 can be implemented by the actor MLP network 430 and the critic MLP network 470 of FIGS. 4B and 4C, respectively (e.g., the trained policy network π_{θ}). For example, the RL-based process 500 can utilize a trained agent to minimize the number of calls to the computationally expensive black-box simulator model 515, based on the trained agent learning to decide between using the simulator model 515 or the surrogate neural network 535 at each time step 512, 514, . . . , etc., of a plurality of time steps of an episode of the RL-based process 500.

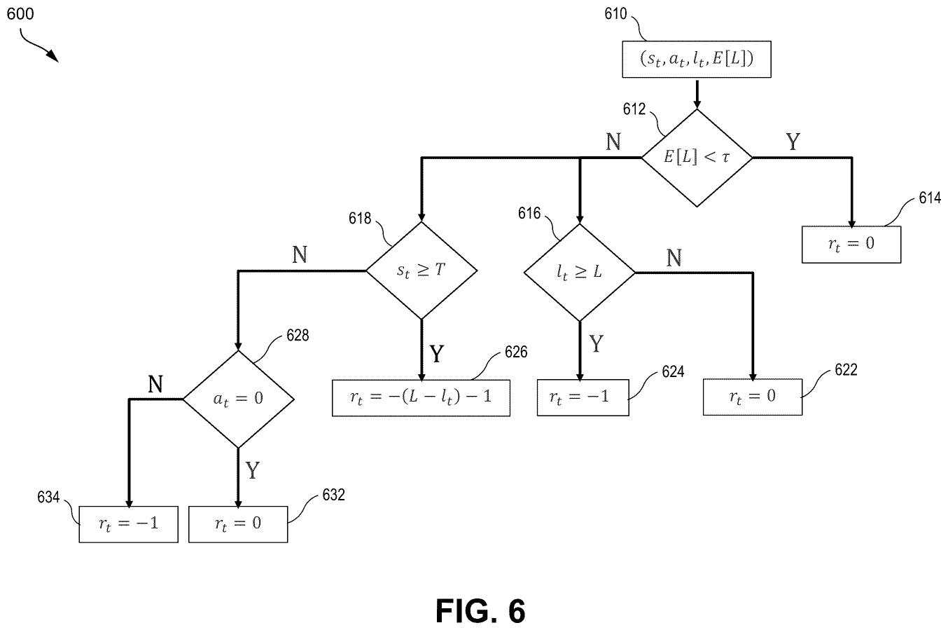

In some aspects, the trained agent utilized by the RL-based process 500 can be a trained actor machine learning network (e.g., neural network), such as the actor MLP 430 of FIG. 4B. The trained agent (e.g., actor MLP 430) can be trained using reinforcement learning techniques to jointly train the agent and a critic network (e.g., critic MLP 470 of FIG. 4C). In some examples, the RL-based training of the actor MLP network 430 and the critic MLP network 470 of FIGS. 4B and 4C, respectively (e.g., the trained policy network π_{θ}) and/or the RL-based training of the agent associated with implementing the process 500 of FIG. 5 can be performed based on the reward model 600 of FIG. 6.

The agent associated with the RL process 500 of FIG. 5 can be associated with an objective, shown in the example of FIG. 5 as the loss function 590. In the first time step 512, an initial input of the parameters being optimized can be obtained as the simulation parameters 502-0, and can be processed using the black-box simulator model 515 to generate as output an initial set of training data

$${D}_{train}^{0}$$

for training the surrogate 535. For example, the training data

$${D}_{train}^{0}$$

can include the outputs y, the inputs x, and the simulation parameters ψ obtained from the simulator 515 for the current timestep 512 (e.g., t=0).

The training data

$${D}_{train}^{0}$$

can be used to perform surrogate training 522, to train the differentiable surrogate neural network 535 to approximate the non-differentiable simulator 515. The learned (e.g., trained) surrogate can be used to calculate gradients ∇_{ψ} of the surrogate, which can be used to perform stochastic gradient descent to solve the inverse problem of optimizing the simulation parameters 502-0 associated with the simulator 505. For example, the surrogate gradients ∇_{ψ} determined in the first time step 512 can be used to update the input simulation parameters 502-0 in a process of iterative optimization. In some aspects, the surrogate gradients ∇_{ψ} can be determined according to Eq. (5), based on determining the gradient(s) of an objective function with respect to the simulation parameters ψ.

The updated simulation parameters 502-1 can be used as input for the next time step 514 (e.g., t+1). The loss function 590 can be used to determine a corresponding loss for each set of simulation parameters during the iterative optimization over the plurality of time steps. For example, the initial t=0 simulation parameters 502-0 are associated with a corresponding loss 592-0. After completing the first time step 512, the updated simulation parameters 502-1 (e.g., generated from the previous simulation parameters 502-0 and the surrogate gradient ∇_{ψ} determined after surrogate training 522) can have a corresponding loss 592-1 that is smaller (e.g., lower on the y-axis of the loss function chart 590) than the loss 592-0.

The updated simulation parameters 502-1 can be used as the current simulation parameters for the second time step 514. For example, the updated simulation parameters 502-1 can be processed by the trained surrogate neural network 535 to generate an approximation corresponding to the simulator 515.

The outputs of the surrogate model 535 can be evaluated by the policy network 537, which can use the trained agent (e.g., the trained actor MLP network 530 of FIG. 4B, etc.) to determine an action a that indicates whether the surrogate output is reliable and does not need to undergo re-training 524, or is unreliable and will undergo the surrogate re-training 524.

If the trained agent of the policy network 537 determines that the re-training of the surrogate is not needed, the surrogate gradients ∇_{ψ} can be determined for the surrogate 535 outputs in the second time step 514, and used to update the simulation parameters 502-1 to thereby generate the updated simulation parameters 502-2. The updated simulation parameters 502-2 can be used as the current simulation parameters for the next time step of the process 500 and iterative optimization. The updated simulation parameters 502-2 can correspond to the loss value 592-2, which is lower than the loss 592-1 corresponding to the simulation parameters 502-1 in the previous step.

If the trained agent of the policy network 537 determines that re-training of the surrogate is needed, the policy network 537 can query the simulator 515 and perform a simulator call to obtain an updated training data set

$${D}_{train}^{0 + 1}$$

for performing the surrogate re-training 524. The trained agent of the policy network 537 can control whether a simulator call is performed in a given time step (e.g., where the simulator 515 is utilized only if the surrogate-retraining 524 is reached from the decision output of the policy network 537). The surrogate re-training 524 can be performed using the updated training data set

$${D}_{train}^{0 + 1} ,$$

and can be the same as or similar to the surrogate training 522 based on the initial training data set

$${D}_{train}^{0}$$

in the first time step 312. After surrogate re-training 524 is completed, the surrogate gradients ∇_{ψ} can be determined based on the re-trained surrogate model 535, and used to generate the updated simulation parameters 502-2.

FIG. 6 is a diagram illustrating an example of a reward model 600 that can be used to train a policy network to determine when to perform simulator calls, in accordance with some examples. In some aspects, the reward model 600 can be used to train an agent of the policy network (e.g., the actor MLP 430 of FIG. 4B, etc.) to solve inverse problems with a computationally expensive, non-differentiable black-box simulator in the loop. For example, the agent can be trained based on the reward model 600 to learn a policy for solving the inverse problem by utilizing the output of a surrogate model as an approximation for the simulator, or by falling back to perform a simulator call when the output of the surrogate model may be unreliable and/or a relatively poor approximation of the simulator. The reward model 600 can be configured to represent constraints such as a limited budget of queries that the agent is allowed to perform to the computationally expensive simulator, the time required to solve the inverse problem, the quality or accuracy of the final solution for the optimization, etc. For example, the reward model 600 can be configured to train the agent to learn trade-offs between speed and quality of the optimization solution determined for the simulator (e.g., determined for the simulation parameters of the simulator) using stochastic gradient descent following the surrogate model gradients.

In some aspects, the reward model 600 can be configured to balance the speed of convergence for solving the inverse problem of optimizing the simulation parameters of the black-box simulator (e.g., the number of simulator calls made by the trained agent or actor network) with the accuracy of the solution (e.g., the accuracy or quality of the final optimized simulation parameters). In some examples, the reward model 600 can be used to train the agent utilizing episodic reinforcement learning techniques. Each optimization inverse problem can correspond to an episode. For example, an episode can be ended in three cases. The first case of episode termination can be reached when the optimization reaches a parameter for which the objective function value is less than a configured threshold value τ.

The reward model 600 can be used to determine a reinforcement learning reward value for training the policy network and associated agent (e.g., actor MLP network 430, etc.). For example, given the current state information 610, the reward model 600 can be used to determine a reward value selected from one of the candidate reward values 614, 622, 624, 626, 632, or 634. The current state information 610 can be represented as (sₜ, aₜ, lₜ, E [Z]).

The reward model 600 can include a first evaluation criteria 612, which determines whether the expected value of the objective function (e.g., loss function) E [L] determined from the current state information 610 is less than a configured threshold t. For example, the configured threshold t can be a target value and/or can represent a termination condition for the optimization. In some aspects, the ‘Y’ branch (e.g., ‘Yes’ branch) from the evaluation criteria 612 can correspond to a first episode termination condition, where the episode is terminated based on the optimization reaching optimized simulation parameter values associated with an objective function value below the target value t. The reward rₜ associated with the ‘Y’ branch from the evaluation criteria 612 can be the reward 614, where rₜ=0.

If the expected value of the objective function (e.g., loss function) E [Z] is not below the target value τ at the end of the current time step (e.g., when the current state information 610 is determined), the reward model can proceed via the ‘N’ branch (e.g., ‘No’ branch) from the evaluation criteria 612, and can compare the state information 610 with one or more of the evaluation criteria 616 and/or 618.

For example, if the expected value of the objective function is not less than the threshold, the reward model 600 can determine whether the maximum number of simulator calls allowed during an episode (e.g., L) has been reached. The evaluation criteria 616 can determine whether the current number of simulator calls that have been made over the duration of the episode (e.g., lₜ of the current state information 610) is less than or equal to the maximum allowed number of simulator calls L.

If the maximum number of simulator calls L has not been reached (e.g., Iₜ≥L evaluates to false), the reward value can be set to the reward 622, rₜ=0. The agent is not penalized, as the agent has not reached or exceeded the specified maximum allowable simulator calls L.

If the maximum number of simulator calls L has been reached (e.g., lₜ≥L evaluates to true at the criteria 616), the agent can be penalized by assigning the reward value 624, rₜ=−1.

Decision criteria 618 can be used to determine whether the maximum number of timesteps T′ has been reached, based on comparing the current number of time steps sₜ to the configured threshold value T indicative of the maximum allowed number of time steps per episode. If the decision criteria 618 evaluates to true (e.g., sₜ≥7), the episode is terminated based on time expiration, and the agent can be penalized by assigning the reward value 626 as rₜ=−(L−lₜ)−1.

If the decision criteria 618 evaluates to false (e.g., sₜ<7), the reward model 600 can evaluate the criteria 628 to determine whether the agent's action for the current time step included an action aₜ associated with a simulator call (e.g., aₜ=0 evaluates to false) or included an action aₜ that was not associated with a simulator call (e.g., aₜ=0 evaluates to true). The criteria 628 can be used to implement a reward penalty for time steps where the agent performs a simulator call, based on assigning the reward value 634 of rₜ=−1. If the agent does not perform a simulator call for the current time step, the reward value 632 of rₜ=0 is used.

In some aspects, the reward model 600 can be configured and used to train the agent with incentivization to reduce the total number of simulator calls performed. For example, the rewards r(sₜ, aₜ, sₜ+1) are 0 if b=0 (e.g., no call to the simulator indicated by the binary decision variable b corresponding to the simulator call decision), and −1 if b=1 (e.g., a call to the simulator is performed, based on the binary decision variable b).

In some examples, the reward model 600 can be configured to incentivize termination of the episode. Termination can occur under a first condition where the agent reaches the reward value 614 (e.g., optimization reaches a simulation parameter for which the expected value of the objective function is below the configured target value t).

Termination can occur under a second condition where the agent reaches the reward penalty value 626, where the maximum number of time steps Thas been reached. The reward penalty 626 can be set to rₜ=−(L−lₜ)−1 in response to reaching the maximum number of time steps T (e.g., sₜ≥T evaluates to true at decision criteria 618 of the reward model 600), to incentivize termination prior to reaching the maximum number of time steps T. For example, the reward penalty value 626 is larger than the other reward values, which may all be either 0 or −1. The increased penalization for reaching the maximum time steps T and receiving the reward penalty 626 can train the agent to incentivize termination prior to reaching the maximum number of time steps T. In some aspects, the reward penalty value 626 can be used to penalize episodes for which the agent did not solve the problem while still having a non-zero budget for calling the computationally expensive simulator. For example, the decision block 618 and the reward penalty 626 cannot be reached in the reward model 600 if zero budget remains for simulator calls, as the simulator call remaining budget is evaluated at decision criteria 616 before evaluating the remaining time budget at the subsequent decision criteria 618.

Termination can occur under a third condition where the agent reaches the reward penalty value 624, corresponding to a determination that the maximum number of simulator calls L allowed per episode has been reached in the current time step t and is indicated by the current state 610 having lₜ≥L. The penalty reward 624 for exhausting the simulator call budget L can be set equal to rₜ=−1, which can ensure that the sum-of-rewards for non-terminating episodes is at most −L−1. In some cases, reward penalties that are primarily based on lₜ, rather than based on t, can improve the training stability.

In some aspects, the systems and techniques can be used to reduce the number of simulator calls performed during inverse problem solving and/or optimization of simulation parameters using surrogate model gradient descent techniques. For example, the systems and techniques can be used to determine and/or control when data is gathered from the simulator using computationally expensive simulator calls, and when the local surrogate model is to be re-trained and/or fine-tuned during inference.

In some examples, a first heuristic can be applied to only perform a simulator call based on a determination that the current y value is outside of the trust-region box (e.g., local neighborhood or configured sampling window, etc.)

$${U}_{ϵ}^{{ψ}^{′}} .$$

Here ψ′ is the simulation parameter value at the last-performed simulator call. The first heuristic can be based on an assumption that the local surrogate model should approximate the simulator well for values inside

$${U}_{ϵ}^{{ψ}^{′}} .$$

Occasionally, repeated gradient steps using the same surrogate may cause loops in the optimization path. In some aspects, the first heuristic can be configured to prevent loops in the optimization path, based on maintaining a counter of consecutive steps since the last simulator call was performed. For example, the first heuristic can be implemented based on the policy network and/or actor MLP network 430 of FIG. 4B being configured to generate an action aₜ for the current time step indicative of a simulator call decision variable value of b=1, in response to a determination that the number of consecutive steps v since the last simulator call is greater than or equal to a configured threshold value. For example, the policy network and/or actor MLP network (e.g., trained agent) can initiate a simulator call based on v≥30 (e.g., a simulator call is performed after v=30 consecutive steps without performing a simulator call, even if the surrogate model accuracy or reliability is otherwise determined to be acceptable).

In some examples, the reward model 600 of FIG. 6, the actor MLP network 430 of FIG. 4B, the critic network 460 of FIG. 4C, etc., can be used to implement a learned policy π_{θ}, parameterized by the policy parameters θ, to decide whether a simulator call is performed or not. The policy can be trained as an online actor-critic reinforcement learning agent with Proximal Policy Optimization (PPO) using Generalized Advantage Estimation (GAE). In some examples, the sequential optimization of the simulation parameters can be formulated as an episodic Markov Decision Process (MDP), with the state sₜ (at timestep t) given by a tuple (ψₜ, t, lₜ, σₜ), where ψₜ is the current parameter value, lₜ is the number of simulator calls already performed this episode, and σₜ represents uncertainty associated with the surrogate approximation(s).

In some examples, the surrogate approximation uncertainty σₜ can be determined based on replacing the local surrogate with an ensemble of local surrogates, all trained on and applied to the same input data. For example, an ensemble of three surrogates can be used, each using the same input data and a different random seed. The respective mean predictions per surrogate can be computed on D samples as

$$\overline{y} = \frac{1}{D} {\sum }_{i = 1}^{D} [ {f}_{ϕ} ( ψ , {x}_{i} ) ] ,$$

and the surrogate approximation uncertainty σₜ can be determined as the standard deviation over D for the mean predictions obtained from each respective surrogate of the ensemble. In some aspects, three surrogates can be used in the ensemble, and a value of D=100 can be utilized with the ensemble.

Actions at can include a binary random variable b∈{0,1}, where 1 represents the decision to perform a simulator call and 0 represents the decision to not perform a simulator call. Actions can optionally include a value ϵₜ, which can be used to determine the size of the trust region for sampling new training values ψ. Transitions T (sₜ, aₜ, sₜ₊₁) can correspond to or include a single step of the Adam optimizer with learning rate 0.1 using local surrogate gradients determined according to Eq. (5) with N=10⁴. As noted previously, episodes can end (e.g., can be terminated) based on the optimization reaching a simulation parameter for which [symbol] [ [symbol] (y)] is below a target value t; based on the maximum number of timesteps T having been reached; or based on the maximum number of simulator calls L having been reached. To incentivize reducing simulator calls, rewards r(sₜ, aₜ, sₜ₊₁) can be set to 0 if b=0, and can be set to −1 if b=1.

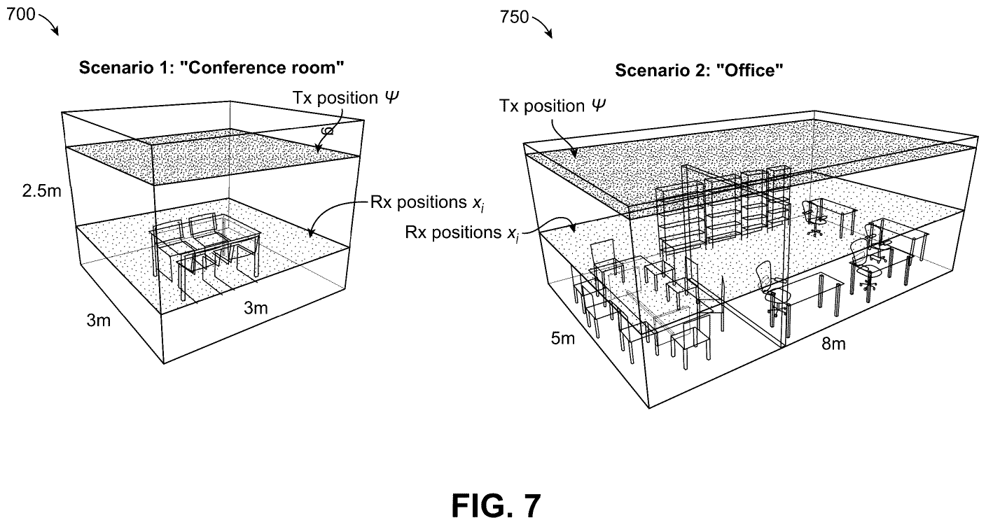

In some examples, the systems and techniques can be used to solve multiple related inverse problems together (e.g., to solve a class or family of multiple related inverse problems). For example, FIG. 7 is a diagram illustrating an example of a first simulation scenario 700 and a second simulation scenario 750 that can be included in a family or class of multiple related inverse problems associated with a black-box simulator. In this example, a non-differentiable or stochastic black-box simulator can be used to solve wireless antenna positioning problems for a first environment 700 (e.g., corresponding to a conference room with floor dimensions of 3 m×3 m) and for a second environment 750 (e.g., corresponding to an office with multiple rooms and total floor dimensions of 5 m×8 m). The systems and techniques can be used to perform optimization of simulation parameters ¿ across both scenarios 700 and 750, and/or when different but similar and/or related simulators are used for the respective scenarios 700 and 750. For example, the choice of underlying simulator may be independent of the training used to generate the learned policy network, which has dependencies in the state information that correspond to the simulation parameters or parameter space, but not the simulator implementation itself. In some aspects, different simulator implementations that use the same or similar simulation parameter spaces ¿ for their simulations can utilize the same trained policy network to control during inference the decision on whether to perform a simulator call. For example, scenario 700 and scenario 750 may be simulated using different black-box simulator models (e.g., one simulator model corresponding to the open space of the conference room of scenario 700, one simulator model corresponding to the divided space of the office of scenario 750), where the black-box simulator models vary in implementation but are the same or similar in their simulation parameter space v associated with the simulation. For example, scenario 700 and scenario 750 can have the same or similar simulation parameter space ψ∈ [symbol] ³, and can both be optimized using the same learned policy network and an appropriately fitted local surrogate for the simulator used in each of scenario 700 and scenario 750. For example, both optimization problems can be solved with the same policy network, a local window size of ϵ=0.5, and inputs indicative of UE locations: (x, y, z)˜U_{[l}_{ₓ}_{,u}_{ₓ}_{]}×U_{[l}_{_{y}}_{,u}_{_{y}}_{]}×U_{[l}_{_{z}}_{,u}_{_{z}}_{]}. Based on the two simulators being included in a family or class of multiple related inverse problems (e.g., a family of inverse optimization problems corresponding to an objective function given by signal strength at the different UE locations), the two simulators can be optimized by the same policy network and trained agent and do not require re-training ab initio (e.g., the same policy network and trained agent can be used to optimize the simulation parameters in scenario 700 and the simulation parameters in scenario 750 to optimize for the (x,y,z) coordinates of the antenna only).

In some aspects, the systems and techniques can be trained on a family of related inverse problems to generalize more effectively to test-time (e.g., inference time) problems. In some aspects, the systems and techniques can be configured to vary the input distribution q (x) between episodes, which corresponds to, e.g., different potential input distributions over an input property. The decision to perform a simulator call or not can be learned or trained to depend on the quality of the local surrogate and not the implementation of the simulator being approximated by the surrogate. A surrogate that is well-fitted to the simulator at the current simulation parameter value can be used to provide useful gradients for the optimization, so gathering additional data and retraining may be unnecessary to adapt a trained policy network and actor or trained agent to perform the optimization for simulation parameters of a different simulator in a family of related inverse problems. In some cases, a badly fitted surrogate will likely not provide useful gradients and may be worth retraining, even if a simulator call is expensive.

In some cases, the systems and techniques can be used to optimize a policy for downstream optimization of multiple related inverse problems. In some aspects, a global surrogate model can be simultaneously trained with the one or more local surrogates. For example, a global surrogate can be trained and used to generate better gradients for inverse problem optimization across the multiple related inverse problems. In some examples, the global surrogate can be jointly optimized with the policy. For example, the policy can output the actions a (e.g., actor MLP 440 actions a 445 of FIG. 4B, etc.) indicative of a value for the decision variable b for whether or not to perform a simulator call, and the values corresponding to the mean and standard deviation of the distribution for sampling the trust-region window size ϵ. In some aspects, the surrogate ensemble can be warm-started from the previous training step every time a decision is made by the actor or trained agent (e.g., actor MLP 440 of FIG. 4B, etc.) of the policy network to perform re-training or fine-tuning of the surrogate. For example, the surrogate ensemble can be configured to implement warm-starting when the simulator call decision variable indicated by the current time step actions aₜ indicates a simulator call decision variable value of b=1. Warm-starting of the surrogate ensemble for the surrogate re-training or fine-tuning step (e.g., such as the surrogate re-training or fine-tuning 524 of FIG. 5) can be used to continuously optimize the surrogate ensemble for trajectories seen during training. For the surrogate ensemble to not forget prior experiences too quickly, a replay buffer can be used to under sample data from earlier iterations geometrically. In some aspects, when training the surrogate with trust-region

$${U}_{ϵ}^{ψ} ,$$

the training data for the surrogate can be generated or obtained to include all data inside

$${U}_{ϵ}^{ψ}$$

for the current episode, half the data inside

$${U}_{ϵ}^{ψ}$$

from the previous episode, a quarter of the data seen two episodes ago, etc. The warm-starting for surrogate re-training or fine-tuning (e.g., surrogate ensemble re-training or fine-tuning) can be used for solving multiple related inverse problems that correspond to a family or class of inverse problems with varying q(x), as only these information about the generalization of the learned policies.

A pseudocode example associated with a process for training the policy network π_{θ} is provided below:

Pseudocode 1: Training the policy network π_{θ}

| | |
|---|---|
| Data: | Simulator fₛ(ψ, x); surrogate f_{ϕ}(ψ, x); observation loss function [symbol] ; policy π_{θ}; |
| | number N of ψ to sample when training the surrogate; number M of x to sample |
| | for each ψ; distributions Q(q) over distributions q(x) to sample x from; initial |
| | value ψ₀; target function value τ; number T of timesteps to run each simulation |
| | (e.g., episode length); maximum number of simulator calls L; ψ optimizer |
| | OPTIM_{ψ} with learning rate λ; number of policy training iterations K; number of |
| | episodes to accumulate for a PPO step G; policy optimizer OPTIM_{π}; reward |
| | function [symbol] ; experience buffer B; discount factor y. |

```
for k ϵ (1, ... , K) do
  Empty experience buffer B.
  for t ϵ (1, ... , G) do
    Initialize number of simulator calls performed in episode: l ← 0.
    Set return: R ← 0.
      Sample x-distribution q ~ Q.
      for t ϵ (1, ... , T) do
      Sample x ~ q(x).
      Obtain surrogate features σ (e.g., ensemble uncertainty) from surrogate
      f_{ϕ}(ψₜ, x).
      Construct state: x ~ q(x).
      Obtain action: a = (do_retrain, trust_region_size) ← π_{θ} (s).
      if do_retrain then
        Obtain N sample ψₙ from trust region with size trust_region_size.
        Obtain M samples xₘ for each of these ψₙ.
        Combine into dataset {ψ, {x}^{M}}^{M} and optionally filter or include data fror
          previous timesteps.
        Retrain surrogate: f_{ϕ} on this dataset.
        Increment number of simulator calls: l ← l + 1.
      end
      Obtain surrogate gradients: gₜ < ∇_{ψ}f_{ϕ}(ψ, x)|_{ψ}_{ₜ}.
      Do optimization step: ψₜ₊₁ ← OPTIM_{ψ}(ψₜ, gₜ, λ).
      terminated < [symbol]     [ [symbol]   (fₛ(ψₜ, x)] ≤ τ
      Obtain reward: r < [symbol]     (s, a, ψₜ₊₁).
      Store (s, a, r) and any other relevant information in buffer B.
      if terminated then
        break
      end
      if l equals L then
        break
      end
    end
  end
  Update policy π ← OPTIM(π_{θ}, B, y).
end
```

A pseudocode example associated with a process for inference using the trained policy network π_{θ} to select between a learned differentiable surrogate model and a black-box non-differentiable (e.g., stochastic) simulator is provided below:

Pseudocode 2: Inference with the trained policy network π_{θ}

| | |
|---|---|
| Data: | Simulator fₛ(ψ, x); surrogate f_{ϕ}(ψ, x); observation loss function [symbol] ; trained |
| | policy π_{θ}; number N of ψ to sample when training the surrogate; number M of |
| | x to sample for each ψ; distributions q(x) to sample x from; initial value ψ₀; |
| | target function value τ; number T of timesteps to run each simulation (e.g., |
| | episode length); maximum number of simulator calls L; ψ optimizer OPTIM_{ψ} |
| | with learning rate λ. |

```
for t ϵ (1, ... , T) do
  Initialize simulator calls done: l ← 0.
  Sample x ~ q(x).
  Obtain surrogate features o (e.g., ensemble uncertainty) from surrogate f_{ϕ} (ψₜ, x).
  Construct state: s < (ψₜ, t, l, σ).
  Obtain action: a = (do_retrain, trust_region_size) ← π_{θ}(s).
  if do_retrain then
    Obtain N samples ψₙ from trust region with size trust_region_size.
    Obtain M samples xₘ for each of these ψₙ .
    Combine into dataset {ψ, {x}^{M}}^{M} and optionally filter or include data from
      previous timesteps.
    Retrain surrogate: f_{ϕ} on this dataset.
    Increment number of simulator calls: l ← l + 1.
  end
  Obtain surrogate gradients: gₜ < ∇_{ψ}f_{ϕ}(ψ, x)|_{ψ}_{ₜ}.
  Do optimization step: ψₜ₊₁ ← OPTIM_{ψ}(ψₜ, gₜ, λ).
  terminated ~ [symbol]     [ [symbol]   (fₛ(ψₜ, x)] ≤ τ
  if terminated then
    Break
  end
  if l equals L then
    break
  end
end
```

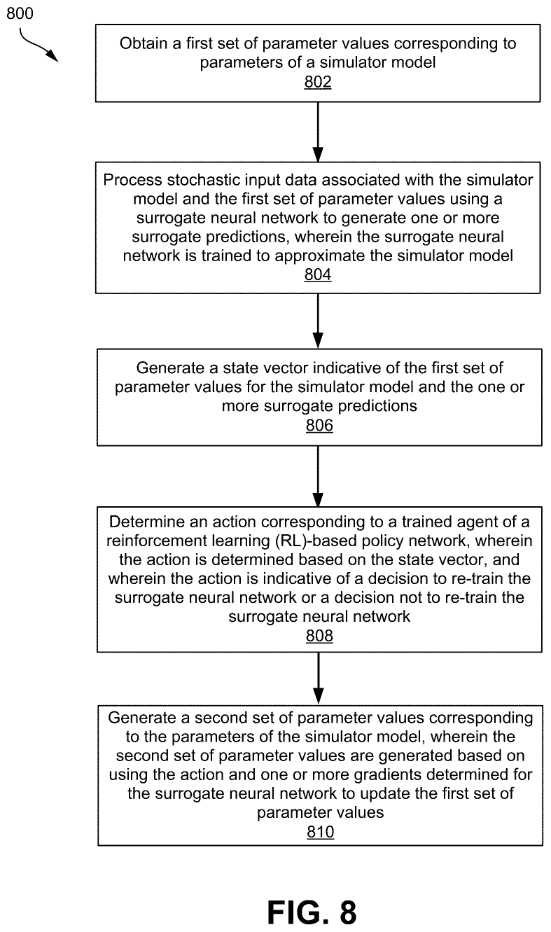

FIG. 8 is a flowchart diagram illustrating an example of a process 800. Although the example process 800 depicts a particular sequence of operations, the sequence may be altered without departing from the scope of the present disclosure. For example, some of the operations depicted may be performed in parallel or in a different sequence that does not materially affect the function of the process 800. In other examples, different components of an example device or system that implements the process 800 may perform functions at substantially the same time or in a specific sequence.

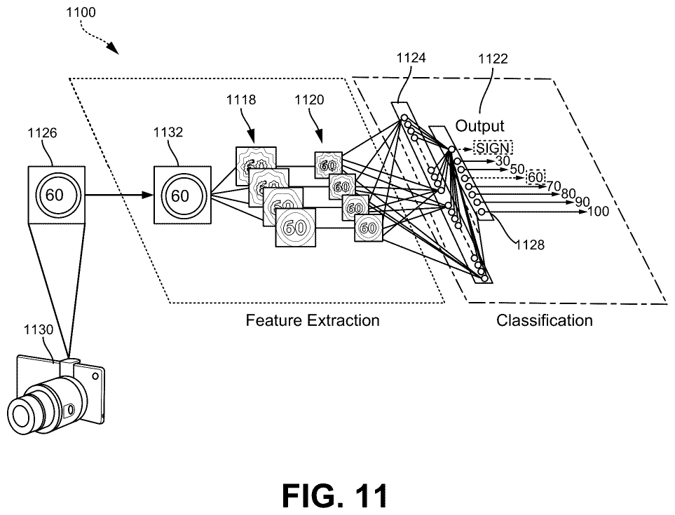

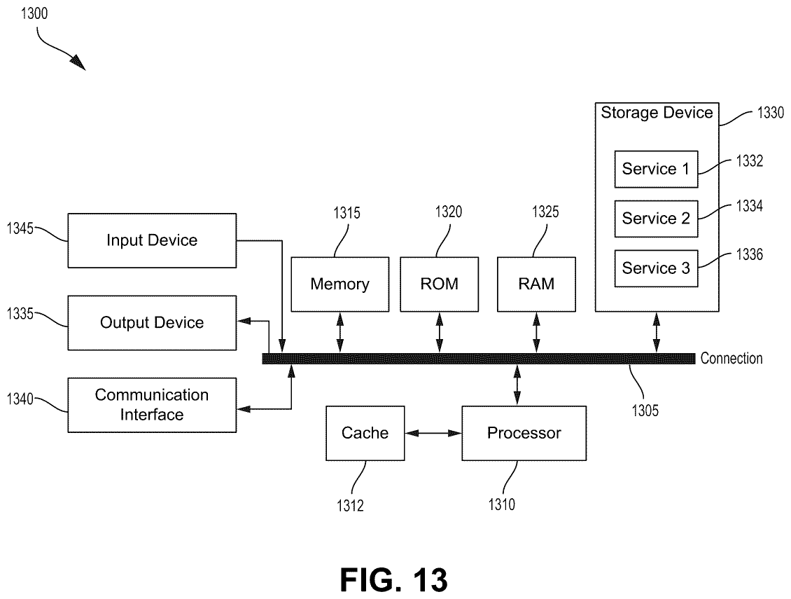

In some examples, the process 800 can be performed by a computing device or apparatus or a component or system (e.g., one or more chipsets, one or more processors such as one or more CPUs, DSPs, NPUs, NSPs, microcontrollers, ASICs, FPGAs, programmable logic devices, discrete gates or transistor logic components, discrete hardware components, etc., any combination thereof, and/or other component or system) of the computing device or apparatus. The operations of the process 800 may be implemented as software components that are executed and run on one or more processors (e.g., processor 1310 of FIG. 13 or other processor(s)). In some examples, the process 800 can be performed by a machine learning network, including any of the machine learning networks and/or neural networks corresponding to the simulator model 362 of FIG. 3A, the simulator model 315 of FIG. 3B, the surrogate machine learning network 335 of FIG. 3B, the surrogate MLP network 410 of FIG. 4A, the actor MLP network 440 of FIG. 4B, the critic MLP network 470 of FIG. 4C, the reinforcement learning process 500 of FIG. 5, the reinforcement learning reward model 600 of FIG. 6, etc. In some aspects, the process 800 can be performed by a UE, smartphone, mobile computing device, user computing device, etc. The process 800 may be performed by an apparatus that may be a mobile device (e.g., a mobile phone), a network-connected wearable such as a watch, an extended reality (XR) device such as a virtual reality (VR) device or augmented reality (AR) device, a vehicle or component or system of a vehicle, or other type of computing device. The operations of the process 800 may be implemented as software components that are executed and run on one or more processors (e.g., processor 1110 of FIG. 11, and/or other processor(s)).

At block 802, the apparatus (or component thereof) can obtain a first set of parameter values corresponding to parameters of a simulator model.

For example, the parameters of the simulator model can be simulation parameters of the simulator model. In some cases, the simulator model can be a black-box and/or non-differentiable and/or stochastic simulator, and may be associated with a plurality of simulation parameters ψ. In some cases, the first set of parameter values can be a first subset of simulation parameter values sampled from the plurality of simulation parameters ψ.

In some cases, the simulator model can be the same as or similar to the simulator model 362 of FIG. 3A, the non-differentiable simulator model 315 of FIG. 3B, the simulator model 515 of FIG. 5, etc. In some examples, the parameters of the simulator model can be simulation parameters the same as or similar to the simulation parameters ψ of FIG. 3A, the simulation parameters 304 of FIG. 3B, etc. In some cases, the first set of parameter values can comprise the sampled simulation parameters included in the set of sampled inputs and simulation parameters 312 of FIG. 3B, sampled from the plurality of continuous simulation parameters 304 of FIG. 3B.

At block 804, the apparatus (or component thereof) can process stochastic input data associated with the simulator model and the first set of parameter values using a surrogate neural network to generate one or more surrogate predictions, wherein the surrogate neural network is trained to approximate the simulator model.

For example, the stochastic input data can be the same as or similar to the input data x of FIG. 3A, the input data distribution 302 of FIG. 3B, etc. In some cases, the surrogate neural network can be the same asor similar to the surrogate machine learning network 335 of FIG. 3B. The surrogate neural network can be a differentiable surrogate neural network associated with the simulator model. In some cases, the simulator is a non-differentiable stochastic simulator, and the surrogate neural network is a learned differentiable model trained to approximate the non-differentiable stochastic simulator.

In some examples, the one or more surrogate predictions can be the same as or similar to the predicted outputs 338 generated by the surrogate mL network 335 of FIG. 3B. In some cases, the surrogate neural network can be the same as or similar to the surrogate MLP 410 of FIG. 4A, and the one or more surrogate predictions can be the same as or similar to the surrogate predictions 415 generated as output by the surrogate MLP 410 of FIG. 4A.

At block 806, the apparatus (or component thereof) can generate a state vector indicative of the first set of parameter values for the simulator model and the one or more surrogate predictions.

For example, the state vector can be the same as or similar to one or more of the state vector inputs 402 of FIG. 4A, the state vector inputs 432 of FIG. 4B, the state vector inputs 462 of FIG. 4C, the state vector 610 of FIG. 6, etc. In some cases, the state vector is indicative of a current time step of a trained agent. For example, the state vector can be indicative of a current time step/associated with a trained agent corresponding to one or more of the actor neural network 440 of FIG. 4B and/or the critic neural network 470 of FIG. 4C. In some cases, the state vector is indicative of a current set of parameter values corresponding to the parameters of the simulator model and determined for the current time step. For example, the current set of parameter values can be the same as or similar to the current simulation parameters w associated with the state vector input 432 to the actor neural network 440 of FIG. 4B and/or the current simulation parameters ¢ associated with the state vector input 462 to the critic neural network 470 of FIG. 4C.

In some cases, the state vector can be indicative of a number of simulator calls performed within a current reinforcement learning episode of the trained agent. For example, the state vector can be indicative of the number of simulator calls/included in the state vector input 432 of FIG. 4B and/or the state vector input 462 of FIG. 4C. In some examples, the number of simulator calls can be the same as the current simulator call counter lₜ indicated by the state vector 610 of FIG. 6.

In some cases, the state vector can be indicative of uncertainty information associated with the one or more surrogate predictions. For example, the state vector can be indicative of the uncertainty information σ included in the state vector input 432 of FIG. 4B and/or the state vector input 462 of FIG. 4C. In some cases, the uncertainty information σ can be the same as or similar to the uncertainty information σ included in the state vector 610 of FIG. 6.

In some cases, the state vector can be indicative of the one or more surrogate predictions based on the state vector including uncertainty information corresponding to an ensemble of a plurality of surrogate neural networks including the surrogate neural network. For example, each respective surrogate neural network of the plurality of surrogate neural networks included in the ensemble can be configured to generate a respective surrogate prediction based on the stochastic input data and the first set of parameter values. Each respective surrogate neural network included in the ensemble can be the same as or similar to the surrogate ML network 335 of FIG. 3B and can generate respective surrogate predictions the same as or similar to the predicted outputs 338 of FIG. 3B, and/or each respective surrogate in the ensemble can be the same as or similar to the surrogate neural network 410 of FIG. 4A and can generate respective surrogate predictions the same as or similar to the predicted surrogate outputs 415 of FIG. 4A.

In some cases, the state vector includes uncertainty information comprising an ensemble uncertainty indicative of an average standard deviation over the respective surrogate predictions.

At block 808, the apparatus (or component thereof) can determine an action corresponding to a trained agent of a reinforcement learning (RL)-based policy network, wherein the action is determined based on the state vector, and wherein the action is indicative of a decision to re-train the surrogate neural network or a decision not to re-train the surrogate neural network.

For example, the trained agent of the RL-based policy network can be an actor-critic reinforcement learning agent comprising an actor neural network and a critic neural network. In some cases, the actor neural network can be the same as or similar to the actor neural network 440 of FIG. 4B and the critic neural network can be the same as or similar to the critic neural network 470 of FIG. 4C.

In some cases, the actor neural network comprises a first multilayer perceptron (MLP) configured to determine the action based on an input comprising the state vector, and the critic neural network comprises a second MLP configured to determine a value function estimate based on the state vector. For example, the action determined by the actor neural network can be the same as or similar to the actions a 445 determined by the actor neural network 440 of FIG. 4B, based on the state vector input 432 of FIG. 4B. The value function estimated determined by the critic neural network can be the same as or similar to the values v 475 determined by the critic neural network 470 of FIG. 4C, based on the state vector input 462 of FIG. 4C. The state vector input 432 of FIG. 4B can be the same as the state vector input 462 of FIG. 4C.

In some cases, the trained agent is a reinforcement learning agent trained based on a reward model including a first configured threshold value corresponding to a maximum of time steps and a second configured threshold value corresponding to a maximum number of simulator calls between the trained agent and the simulator model. In some examples, the reward model further includes a third configured threshold value corresponding to an objective function determined based on the parameters of the simulator model.

For example, the reward model can be the same as or similar to the reward model 600 of FIG. 6. In some cases, the first configured threshold value can be the same as or similar to the threshold comparison 618 included in the reward model 600 of FIG. 6, and the second configured threshold value can be the same as or similar to the threshold comparison 616 included in the reward model 600 of FIG. 6. In some examples, the third configured threshold value can be the same as or similar to the threshold comparison 612 included in the reward model 600 of FIG. 6. In some cases, the agent is configured to perform a simulator call based on the decision to re-train the surrogate neural network.

In some examples, the apparatus (or component thereof) can be configured to re-train the surrogate neural network based on the action being indicative of the decision to re-train the surrogate neural network. For example, the surrogate neural network can be re-trained based on the surrogate re-training 524 of FIG. 5. In some cases, to re-train the surrogate neural network, the apparatus (or component thereof) can be configured to perform a simulator call between the trained agent and the simulator model, wherein the simulator call corresponds to evaluating a forward process of the simulator model. The surrogate neural network can be re-trained using a dataset sampled from a local neighborhood within a current set of parameter values associated with evaluating the forward process of the simulator model.

In some cases, the stochastic input data is sampled from an input distribution associated with the simulator model, and the apparatus (or component thereof) can be configured to re-train the surrogate neural network using the dataset sampled from the local neighborhood within the current set of parameter values and further using a plurality of input data samples sampled from the input distribution.

In some examples, the action corresponding to the trained agent is indicative of a decision variable indicative of the decision to re-train or the decision not to re-train the surrogate neural network. For example, the action a 445 determined by the actor MLP 440 of FIG. 4B can be indicative of a decision variable indicative of the decision to re-train or the decision not to re-train the surrogate neural network using the surrogate re-training 524 of FIG. 5. In some examples, the action corresponding to the trained agent is indicative of one or more values indicative of a window size for the local neighborhood within the current set of parameter values associated with evaluating the forward process of the simulator model. In some examples, the one or more values comprise a mean value and a standard deviation value associated with a lognormal distribution determined by the trained agent, and wherein the window size is sampled from the lognormal distribution using the mean value and the standard deviation value. In some cases, to re-train the surrogate neural network, the apparatus (or component thereof) can be configured to obtain a training dataset comprising data sampled from the simulator model and re-train the surrogate neural network using the data sampled from the simulator model.

At block 810, the apparatus (or component thereof) can generate a second set of parameter values corresponding to the parameters of the simulator model, wherein the second set of parameter values are generated based on using the action and one or more gradients determined for the surrogate neural network to update the first set of parameter values.

For example, the first set of parameter values can correspond to the first time step 512 of FIG. 5, and the second set of parameter values can correspond to the second time step 514 of FIG. 5. In some cases, to re-train the surrogate neural network, the apparatus (or component thereof) can be configured to obtain a training dataset comprising data sampled from the simulator model, and re-train the surrogate neural network using the data sampled from the simulator model. For example, the surrogate re-training 524 of FIG. 5 can be based on obtaining a training dataset comprising data sampled from the simulator model 515 of FIG. 5, and re-training the surrogate neural network 535 of FIG. 5 using the data sampled from the simulator model 515. In some cases, the apparatus (or component thereof) can be configured to determine the one or more gradients after the surrogate neural network is re-trained.

In some examples, the processes described herein (e.g., the process 800 and/or any other process described herein) may be performed by a computing device or apparatus. In some aspects, the process 800 and/or other technique or process described herein can be performed by a computing system having an architecture according to any of FIGS. 1-7B. In another example, the process 800 and/or other technique or process described herein can be performed by the computing system 1300 shown in FIG. 13. In some examples, the computing device can include a mobile device (e.g., a mobile phone, a tablet computing device, etc.), a wearable device, an extended reality device (e.g., a virtual reality (VR) device, an augmented reality (AR) device, or a mixed reality (MR) device), a personal computer, a laptop computer, a video server, a television, a vehicle (or a computing device of a vehicle), robotic device, and/or any other computing device with the resource capabilities to perform the processes described herein.

In some cases, the computing device or apparatus may include various components, such as one or more input devices, one or more output devices, one or more processors, one or more microprocessors, one or more microcomputers, one or more transmitters, receivers or combined transmitter-receivers (e.g., referred to as transceivers), one or more cameras, one or more sensors, and/or other component(s) that are configured to carry out the steps of processes described herein. In some examples, the computing device may include a display, a network interface configured to communicate and/or receive the data, any combination thereof, and/or other component(s). The network interface may be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), neural processing units (NPUs), and/or other suitable electronic circuits), and/or can include and/or be implemented using computer software, firmware, or any combination thereof, to perform the various operations described herein.

The processes described herein may be illustrated or described as a logical flow diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the processes described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

As noted previously, neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

FIG. 9 is an illustrative example of a deep learning neural network 900. An input layer 920 includes input data. In some cases, the input layer 920 can include data representing the pixels of an input video frame. The neural network 900 includes multiple hidden layers 922a, 922b, through 922n. The hidden layers 922a, 922b, through 922n include “n” number of hidden layers, where “n” is an integer greater than or equal to one. The number of hidden layers can be made to include as many layers as needed for the given application. The neural network 900 further includes an output layer 924 that provides an output resulting from the processing performed by the hidden layers 922a, 922b, through 922n. In some aspects, the output layer 924 can provide a classification for an object in an input video frame. The classification can include a class identifying the type of object (e.g., a person, a dog, a cat, or other object).

The neural network 900 is a multi-layer neural network of interconnected nodes. Each node can represent a piece of information. Information associated with the nodes is shared among the different layers and each layer retains information as information is processed. In some cases, the neural network 900 can include a feed-forward network, in which case there are no feedback connections where outputs of the network are fed back into itself. In some cases, the neural network 900 can include a recurrent neural network, which can have loops that allow information to be carried across nodes while reading in input.

Information can be exchanged between nodes through node-to-node interconnections between the various layers. Nodes of the input layer 920 can activate a set of nodes in the first hidden layer 922a. For example, as shown, each of the input nodes of the input layer 920 is connected to each of the nodes of the first hidden layer 922a. The nodes of the hidden layers 922a, 922b, through 922n can transform the information of each input node by applying activation functions to the information. The information derived from the transformation can then be passed to and can activate the nodes of the next hidden layer 922b, which can perform their own designated functions. Example functions include convolutional, up-sampling, data transformation, and/or any other suitable functions. The output of the hidden layer 922b can then activate nodes of the next hidden layer, and so on. The output of the last hidden layer 922n can activate one or more nodes of the output layer 924, at which an output is provided. In some cases, while nodes (e.g., node 926) in the neural network 900 are shown as having multiple output lines, a node has a single output and all lines shown as being output from a node represent the same output value.

In some cases, each node or interconnection between nodes can have a weight that is a set of parameters derived from the training of the neural network 900. Once the neural network 900 is trained, it can be referred to as a trained neural network, which can be used to classify one or more objects. For example, an interconnection between nodes can represent a piece of information learned about the interconnected nodes. The interconnection can have a tunable numeric weight that can be tuned (e.g., based on a training dataset), allowing the neural network 900 to be adaptive to inputs and able to learn as more and more data is processed.

The neural network 900 is pre-trained to process the features from the data in the input layer 920 using the different hidden layers 922a, 922b, through 922n in order to provide the output through the output layer 924. In an example in which the neural network 900 is used to identify objects in images, the neural network 900 can be trained using training data that includes both images and labels. For instance, training images can be input into the network, with each training image having a label indicating the classes of the one or more objects in each image (basically, indicating to the network what the objects are and what features they have). In some examples, a training image can include an image of a number 2, in which case the label for the image can be [0 0 1 0 0 0 0 0 0 0].

In some cases, the neural network 900 can adjust the weights of the nodes using a training process called backpropagation. Backpropagation can include a forward pass, a loss function, a backward pass, and a weight update. The forward pass, loss function, backward pass, and parameter update is performed for one training iteration. The process can be repeated for a certain number of iterations for each set of training images until the neural network 900 is trained well enough so that the weights of the layers are accurately tuned.

For the example of identifying objects in images, the forward pass can include passing a training image through the neural network 900. The weights are initially randomized before the neural network 900 is trained. The image can include, for example, an array of numbers representing the pixels of the image. Each number in the array can include a value from 0 to 255 describing the pixel intensity at that position in the array. In some examples, the array can include a 28×28×3 array of numbers with 28 rows and 28 columns of pixels and 3 color components (such as red, green, and blue, or luma and two chroma components, or the like).

For a first training iteration for the neural network 900, the output will likely include values that do not give preference to any particular class due to the weights being randomly selected at initialization. For example, if the output is a vector with probabilities that the object includes different classes, the probability value for each of the different classes may be equal or at least very similar (e.g., for ten possible classes, each class may have a probability value of 0.1). With the initial weights, the neural network 900 is unable to determine low level features and thus cannot make an accurate determination of what the classification of the object might be. A loss function can be used to analyze error in the output. Any suitable loss function definition can be used. One example of a loss function includes a mean squared error (MSE). The MSE is defined as

$${E}_{total} = \sum \frac{1}{2} {( target - output )}^{2} ,$$

which calculates the sum of one-half times a ground truth output (e.g., the actual answer) minus the predicted output (e.g., the predicted answer) squared. The loss can be set to be equal to the value of Eₜₒₜₐₗ.

The loss (or error) will be high for the first training images since the actual values will be much different than the predicted output. The goal of training is to minimize the amount of loss so that the predicted output is the same as the training label. The neural network 900 can perform a backward pass by determining which inputs (weights) most contributed to the loss of the network, and can adjust the weights so that the loss decreases and is eventually minimized.

A derivative of the loss with respect to the weights (denoted as dL/dW, where W are the weights at a particular layer) can be computed to determine the weights that contributed most to the loss of the network. After the derivative is computed, a weight update can be performed by updating all the weights of the filters. For example, the weights can be updated so that they change in the opposite direction of the gradient. The weight update can be denoted as

$$w = {w}_{i} - η \frac{dL}{dW} ,$$

where w denotes a weight, wᵢ denotes the initial weight, and η denotes a learning rate. The learning rate can be set to any suitable value, with a high learning rate including larger weight updates and a lower value indicating smaller weight updates.

The neural network 900 can include any suitable deep network. One example includes a convolutional neural network (CNN), which includes an input layer and an output layer, with multiple hidden layers between the input and out layers. An example of a CNN is described below with respect to FIG. 10. The hidden layers of a CNN include a series of convolutional, nonlinear, pooling (for downsampling), and fully connected layers. The neural network 900 can include any other deep network other than a CNN, such as an autoencoder, a deep belief nets (DBNs), a Recurrent Neural Networks (RNNs), among others.

FIG. 10 is an illustrative example of a convolutional neural network 1000 (CNN 1000). The input layer 1020 of the CNN 1000 includes data representing an image. For example, the data can include an array of numbers representing the pixels of the image, with each number in the array including a value from 0 to 255 describing the pixel intensity at that position in the array. Using the previous example from above, the array can include a 28×28×3 array of numbers with 28 rows and 28 columns of pixels and 3 color components (e.g., red, green, and blue, or luma and two chroma components, or the like). The image can be passed through a convolutional hidden layer 1022a, an optional non-linear activation layer, a pooling hidden layer 1022b, and fully connected hidden layers 1022c to get an output at the output layer 1024. While only one of each hidden layer is shown in FIG. 10, one of ordinary skill will appreciate that multiple convolutional hidden layers, non-linear layers, pooling hidden layers, and/or fully connected layers can be included in the CNN 1000. As previously described, the output can indicate a single class of an object or can include a probability of classes that best describe the object in the image.

The first layer of the CNN 1000 is the convolutional hidden layer 1022a. The convolutional hidden layer 1022a analyzes the image data of the input layer 1020. Each node of the convolutional hidden layer 1022a is connected to a region of nodes (pixels) of the input image called a receptive field. The convolutional hidden layer 1022a can be considered as one or more filters (each filter corresponding to a different activation or feature map), with each convolutional iteration of a filter being a node or neuron of the convolutional hidden layer 1022a. For example, the region of the input image that a filter covers at each convolutional iteration would be the receptive field for the filter. In some aspects, if the input image includes a 28×28 array, and each filter (and corresponding receptive field) is a 5×5 array, then there will be 24×24 nodes in the convolutional hidden layer 1022a. Each connection between a node and a receptive field for that node learns a weight and, in some cases, an overall bias such that each node learns to analyze its particular local receptive field in the input image. Each node of the hidden layer 1022a will have the same weights and bias (called a shared weight and a shared bias). For example, the filter has an array of weights (numbers) and the same depth as the input. A filter will have a depth of 3 for the video frame example (according to three color components of the input image). An illustrative example size of the filter array is 5×5×3, corresponding to a size of the receptive field of a node.

The convolutional nature of the convolutional hidden layer 1022a is due to each node of the convolutional layer being applied to its corresponding receptive field. For example, a filter of the convolutional hidden layer 1022a can begin in the top-left corner of the input image array and can convolve around the input image. As noted above, each convolutional iteration of the filter can be considered a node or neuron of the convolutional hidden layer 1022a. At each convolutional iteration, the values of the filter are multiplied with a corresponding number of the original pixel values of the image (e.g., the 5×5 filter array is multiplied by a 5×5 array of input pixel values at the top-left corner of the input image array). The multiplications from each convolutional iteration can be summed together to obtain a total sum for that iteration or node. The process is next continued at a next location in the input image according to the receptive field of a next node in the convolutional hidden layer 1022a.

For example, a filter can be moved by a step amount to the next receptive field. The step amount can be set to 1 or other suitable amount. For example, if the step amount is set to 1, the filter will be moved to the right by 1 pixel at each convolutional iteration. Processing the filter at each unique location of the input volume produces a number representing the filter results for that location, resulting in a total sum value being determined for each node of the convolutional hidden layer 1022a.

The mapping from the input layer to the convolutional hidden layer 1022a is referred to as an activation map (or feature map). The activation map includes a value for each node representing the filter results at each locations of the input volume. The activation map can include an array that includes the various total sum values resulting from each iteration of the filter on the input volume. For example, the activation map will include a 24×24 array if a 5×5 filter is applied to each pixel (a step amount of 1) of a 28×28 input image. The convolutional hidden layer 1022a can include several activation maps in order to identify multiple features in an image. The example shown in FIG. 10 includes three activation maps. Using three activation maps, the convolutional hidden layer 1022a can detect three different kinds of features, with each feature being detectable across the entire image.

In some examples, a non-linear hidden layer can be applied after the convolutional hidden layer 1022a. The non-linear layer can be used to introduce non-linearity to a system that has been computing linear operations. An example of a non-linear layer is a rectified linear unit (ReLU) layer. A ReLU layer can apply the function ƒ(x)=max (0, x) to all of the values in the input volume, which changes all the negative activations to 0. The ReLU can thus increase the non-linear properties of the CNN 1000 without affecting the receptive fields of the convolutional hidden layer 1022a.

The pooling hidden layer 1022b can be applied after the convolutional hidden layer 1022a (and after the non-linear hidden layer when used). The pooling hidden layer 1022b is used to simplify the information in the output from the convolutional hidden layer 1022a. For example, the pooling hidden layer 1022b can take each activation map output from the convolutional hidden layer 1022a and generates a condensed activation map (or feature map) using a pooling function. Max-pooling is an example of a function performed by a pooling hidden layer. Other forms of pooling functions be used by the pooling hidden layer 1022a, such as average pooling, L2-norm pooling, or other suitable pooling functions. A pooling function (e.g., a max-pooling filter, an L2-norm filter, or other suitable pooling filter) is applied to each activation map included in the convolutional hidden layer 1022a. In the example shown in FIG. 10, three pooling filters are used for the three activation maps in the convolutional hidden layer 1022a.

In some examples, max-pooling can be used by applying a max-pooling filter (e.g., having a size of 2×2) with a step amount (e.g., equal to a dimension of the filter, such as a step amount of 2) to an activation map output from the convolutional hidden layer 1022a. The output from a max-pooling filter includes the maximum number in every sub-region that the filter convolves around. Using a 2×2 filter as an example, each unit in the pooling layer can summarize a region of 2×2 nodes in the previous layer (with each node being a value in the activation map). For example, four values (nodes) in an activation map will be analyzed by a 2×2 max-pooling filter at each iteration of the filter, with the maximum value from the four values being output as the “max” value. If such a max-pooling filter is applied to an activation filter from the convolutional hidden layer 1022a having a dimension of 24×24 nodes, the output from the pooling hidden layer 1022b will be an array of 12×12 nodes.

In some examples, an L2-norm pooling filter could also be used. The L2-norm pooling filter includes computing the square root of the sum of the squares of the values in the 2×2 region (or other suitable region) of an activation map (instead of computing the maximum values as is done in max-pooling), and using the computed values as an output.

Intuitively, the pooling function (e.g., max-pooling, L2-norm pooling, or other pooling function) determines whether a given feature is found anywhere in a region of the image, and discards the exact positional information. This can be done without affecting results of the feature detection because, once a feature has been found, the exact location of the feature is not as important as its approximate location relative to other features. Max-pooling (as well as other pooling methods) offer the benefit that there are many fewer pooled features, thus reducing the number of parameters needed in later layers of the CNN 1000.

The final layer of connections in the network is a fully-connected layer that connects every node from the pooling hidden layer 1022b to every one of the output nodes in the output layer 1024. Using the example above, the input layer includes 28×28 nodes encoding the pixel intensities of the input image, the convolutional hidden layer 1022a includes 3×24×24 hidden feature nodes based on application of a 5×5 local receptive field (for the filters) to three activation maps, and the pooling layer 1022b includes a layer of 3×12×12 hidden feature nodes based on application of max-pooling filter to 2×2 regions across each of the three feature maps. Extending this example, the output layer 1024 can include ten output nodes. In such an example, every node of the 3×12×12 pooling hidden layer 1022b is connected to every node of the output layer 1024.

The fully connected layer 1022c can obtain the output of the previous pooling layer 1022b (which should represent the activation maps of high-level features) and determines the features that most correlate to a particular class. For example, the fully connected layer 1022c layer can determine the high-level features that most strongly correlate to a particular class, and can include weights (nodes) for the high-level features. A product can be computed between the weights of the fully connected layer 1022c and the pooling hidden layer 1022b to obtain probabilities for the different classes. For example, if the CNN 1000 is being used to predict that an object in a video frame is a person, high values will be present in the activation maps that represent high-level features of people (e.g., two legs are present, a face is present at the top of the object, two eyes are present at the top left and top right of the face, a nose is present in the middle of the face, a mouth is present at the bottom of the face, and/or other features common for a person).

In some examples, the output from the output layer 1024 can include an M-dimensional vector (in the prior example, M=10), where M can include the number of classes that the program has to choose from when classifying the object in the image. Other example outputs can also be provided. Each number in the N-dimensional vector can represent the probability the object is of a certain class. In some cases, if a 10-dimensional output vector represents ten different classes of objects is [0 0 0.05 0.8 00.15 0 0 0 0], the vector indicates that there is a 5% probability that the image is the third class of object (e.g., a dog), an 80% probability that the image is the fourth class of object (e.g., a human), and a 15% probability that the image is the sixth class of object (e.g., a kangaroo). The probability for a class can be considered a confidence level that the object is part of that class.

One type of convolutional neural network is a deep convolutional network (DCN). FIG. 11 illustrates a detailed example of a DCN 1100 designed to recognize visual features from an image 1126 input from an image capturing device 1130, such as a car-mounted camera. The DCN 1100 of the current example may be trained to identify traffic signs and a number provided on the traffic sign. Of course, the DCN 1100 may be trained for other tasks, such as identifying lane markings or identifying traffic lights.

The DCN 1100 may be trained with supervised learning. During training, the DCN 1100 may be presented with an image, such as the image 1126 of a speed limit sign, and a forward pass may then be computed to produce an output 1122. The DCN 1100 may include a feature extraction section and a classification section. Upon receiving the image 1126, a convolutional layer 1132 may apply convolutional kernels (not shown) to the image 1126 to generate a first set of feature maps 1118. As an example, the convolutional kernel for the convolutional layer 1132 may be a 5×5 kernel that generates 28×28 feature maps. In the present example, because four different feature maps are generated in the first set of feature maps 1118, four different convolutional kernels were applied to the image 1126 at the convolutional layer 1132. The convolutional kernels may also be referred to as filters or convolutional filters.

The first set of feature maps 1118 may be subsampled by a max pooling layer (not shown) to generate a second set of feature maps 1120. The max pooling layer reduces the size of the first set of feature maps 1118. That is, a size of the second set of feature maps 1120, such as 14×14, is less than the size of the first set of feature maps 1118, such as 28×28. The reduced size provides similar information to a subsequent layer while reducing memory consumption. The second set of feature maps 1120 may be further convolved via one or more subsequent convolutional layers (not shown) to generate one or more subsequent sets of feature maps (not shown).

In the example of FIG. 11, the second set of feature maps 1120 is convolved to generate a first feature vector 1124. Furthermore, the first feature vector 1124 is further convolved to generate a second feature vector 1128. Each feature of the second feature vector 1128 may include a number that corresponds to a possible feature of the image 1126, such as “sign,” “60,” and “100.” A softmax function (not shown) may convert the numbers in the second feature vector 1128 to a probability. As such, an output 1122 of the DCN 1100 is a probability of the image 1126 including one or more features.

In the present example, the probabilities in the output 1122 for “sign” and “60” are higher than the probabilities of the others of the output 1122, such as “30,” “40,” “50,” “70,” “80,” “90,” and “100”. Before training, the output 1122 produced by the DCN 1100 is likely to be incorrect. Thus, an error may be calculated between the output 1122 and a target output. The target output is the ground truth of the image 1126 (e.g., “sign” and “60”). The weights of the DCN 1100 may then be adjusted so the output 1122 of the DCN 1100 is more closely aligned with the target output.

To adjust the weights, a learning algorithm may compute a gradient vector for the weights. The gradient may indicate an amount that an error would increase or decrease if the weight were adjusted. At the top layer, the gradient may correspond directly to the value of a weight connecting an activated neuron in the penultimate layer and a neuron in the output layer. In lower layers, the gradient may depend on the value of the weights and on the computed error gradients of the higher layers. The weights may then be adjusted to reduce the error. This manner of adjusting the weights may be referred to as “back propagation” as it involves a “backward pass” through the neural network.

In practice, the error gradient of weights may be calculated over a small number of examples, so that the calculated gradient approximates the true error gradient. This approximation method may be referred to as stochastic gradient descent. Stochastic gradient descent may be repeated until the achievable error rate of the entire system has stopped decreasing or until the error rate has reached a target level. After learning, the DCN may be presented with new images and a forward pass through the network may yield an output 1122 that may be considered an inference or a prediction of the DCN.

Deep belief networks (DBNs) are probabilistic models comprising multiple layers of hidden nodes. DBNs may be used to extract a hierarchical representation of training data sets. A DBN may be obtained by stacking up layers of Restricted Boltzmann Machines (RBMs). An RBM is a type of artificial neural network that can learn a probability distribution over a set of inputs. Because RBMs can learn a probability distribution in the absence of information associated with the class to which each input should be categorized, RBMs are often used in unsupervised learning. Using a hybrid unsupervised and supervised paradigm, the bottom RBMs of a DBN may be trained in an unsupervised manner and may serve as feature extractors, and the top RBM may be trained in a supervised manner (on a joint distribution of inputs from the previous layer and target classes) and may serve as a classifier.

Deep convolutional networks (DCNs) are networks of convolutional networks, configured with additional pooling and normalization layers. DCNs have achieved state-of-the-art performance on many tasks. DCNs can be trained using supervised learning in which both the input and output targets are known for many exemplars and are used to modify the weights of the network by use of gradient descent methods.

DCNs may be feed-forward networks. In addition, as described above, the connections from a neuron in a first layer of a DCN to a group of neurons in the next higher layer are shared across the neurons in the first layer. The feed-forward and shared connections of DCNs may be exploited for fast processing. The computational burden of a DCN may be much less, for example, than that of a similarly sized neural network that comprises recurrent or feedback connections.

The processing of each layer of a convolutional network may be considered a spatially invariant template or basis projection. If the input is first decomposed into multiple channels, such as the red, green, and blue channels of a color image, then the convolutional network trained on that input may be considered three-dimensional, with two spatial dimensions along the axes of the image and a third dimension capturing color information. The outputs of the convolutional connections may be considered to form a feature map in the subsequent layer, with each element of the feature map (e.g., 1120) receiving input from a range of neurons in the previous layer (e.g., feature maps 1118) and from each of the multiple channels. The values in the feature map may be further processed with a non-linearity, such as a rectification, max(0,x). Values from adjacent neurons may be further pooled, which corresponds to down sampling, and may provide additional local invariance and dimensionality reduction.

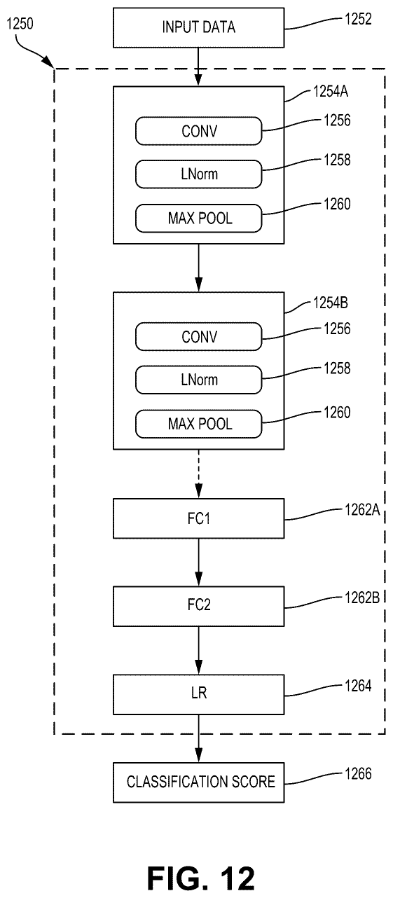

FIG. 12 is a block diagram illustrating an example of a deep convolutional network (DCN) 1250. The deep convolutional network 1250 may include multiple different types of layers based on connectivity and weight sharing. As shown in FIG. 12, the deep convolutional network 1250 includes the convolution blocks 1254A, 1254B. Each of the convolution blocks 1254A, 1254B may be configured with a convolution layer (CONV) 1256, a normalization layer (LNorm) 1258, and a max pooling layer (MAX POOL) 1260.

The convolution layers 1256 may include one or more convolutional filters, which may be applied to the input data 1252 to generate a feature map. Although only two convolution blocks 1254A, 1254B are shown, the present disclosure is not so limiting, and instead, any number of convolution blocks (e.g., blocks 1254A, 1254B) may be included in the deep convolutional network 1250 according to design preference. The normalization layer 1258 may normalize the output of the convolution filters. For example, the normalization layer 1258 may provide whitening or lateral inhibition. The max pooling layer 1260 may provide down sampling aggregation over space for local invariance and dimensionality reduction.

The parallel filter banks, for example, of a deep convolutional network may be loaded on a CPU or GPU of an SOC (e.g., such as the CPU 102 or GPU 104 of the SOC 100 of FIG. 1, etc.) to achieve high performance and low power consumption. In alternative aspects, the parallel filter banks may be loaded on the DSP 106 or an ISP 116 of the SOC 100 of FIG. 1. In addition, the deep convolutional network 1250 may access other processing blocks that may be present on the SOC 100 of FIG. 1, such as sensor processor 114 and storage 120, etc.

The deep convolutional network 1250 may also include one or more fully connected layers, such as layer 1262A (labeled “FC1”) and layer 1262B (labeled “FC2”). The deep convolutional network 1250 may further include a logistic regression (LR) layer 1264. Between each layer 1256, 1258, 1260, 1262A, 1262B, 1264 of the deep convolutional network 1250 are weights (not shown) that are to be updated. The output of each of the layers (e.g., 1256, 1258, 1260, 1262A, 1262B, 1264) may serve as an input of a succeeding one of the layers (e.g., 1256, 1258, 1260, 1262A, 1262B, 1264) in the deep convolutional network 1250 to learn hierarchical feature representations from input data 1252 (e.g., images, audio, video, sensor data and/or other input data) supplied at the first of the convolution blocks 1254A. The output of the deep convolutional network 1250 is a classification score 1266 for the input data 1252. The classification score 1266 may be a set of probabilities, where each probability is the probability of the input data including a feature from a set of features.

FIG. 13 illustrates an example computing device architecture 1300 of an example computing device which can implement the various techniques described herein. In some examples, the computing device can include a mobile device, a wearable device, an extended reality device (e.g., a virtual reality (VR) device, an augmented reality (AR) device, or a mixed reality (MR) device), a personal computer, a laptop computer, a video server, a vehicle (or computing device of a vehicle), or other device. The components of computing device architecture 1300 are shown in electrical communication with each other using connection 1305, such as a bus. The example computing device architecture 1300 includes a processing unit (CPU or processor) 1310 and computing device connection 1305 that couples various computing device components including computing device memory 1315, such as read only memory (ROM) 1320 and random access memory (RAM) 1325, to processor 1310.

Computing device architecture 1300 can include a cache of high-speed memory connected directly with, in close proximity to, or integrated as part of processor 1310. Computing device architecture 1300 can copy data from memory 1315 and/or the storage device 1330 to cache 1312 for quick access by processor 1310. In this way, the cache can provide a performance boost that avoids processor 1310 delays while waiting for data. These and other modules can control or be configured to control processor 1310 to perform various actions. Other computing device memory 1315 may be available for use as well. Memory 1315 can include multiple different types of memory with different performance characteristics. Processor 1310 can include any general purpose processor and a hardware or software service, such as service 1 1332, service 2 1334, and service 3 1336 stored in storage device 1330, configured to control processor 1310 as well as a special-purpose processor where software instructions are incorporated into the processor design. Processor 1310 may be a self-contained system, containing multiple cores or processors, a bus, memory controller, cache, etc. A multi-core processor may be symmetric or asymmetric.

To enable user interaction with the computing device architecture 1300, input device 1345 can represent any number of input mechanisms, such as a microphone for speech, a touch-sensitive screen for gesture or graphical input, keyboard, mouse, motion input, speech and so forth. Output device 1335 can also be one or more of a number of output mechanisms known to those of skill in the art, such as a display, projector, television, speaker device, etc. In some instances, multimodal computing devices can enable a user to provide multiple types of input to communicate with computing device architecture 1300. Communication interface 1340 can generally govern and manage the user input and computing device output. There is no restriction on operating on any particular hardware arrangement and therefore the basic features here may easily be substituted for improved hardware or firmware arrangements as they are developed.

Storage device 1330 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 1325, read only memory (ROM) 1320, and hybrids thereof. Storage device 1330 can include services 1332, 1334, 1336 for controlling processor 1310. Other hardware or software modules are contemplated. Storage device 1330 can be connected to the computing device connection 1305. In some aspects, a hardware module that performs a particular function can include the software component stored in a computer-readable medium in connection with the necessary hardware components, such as processor 1310, connection 1305, output device 1335, and so forth, to carry out the function.

Aspects of the present disclosure are applicable to any suitable electronic device (such as security systems, smartphones, tablets, laptop computers, vehicles, drones, or other devices) including or coupled to one or more active depth sensing systems. While described below with respect to a device having or coupled to one light projector, aspects of the present disclosure are applicable to devices having any number of light projectors, and are therefore not limited to specific devices.

The term “device” is not limited to one or a specific number of physical objects (such as one smartphone, one controller, one processing system and so on). As used herein, a device may be any electronic device with one or more parts that may implement at least some portions of this disclosure. While the below description and examples use the term “device” to describe various aspects of this disclosure, the term “device” is not limited to a specific configuration, type, or number of objects. Additionally, the term “system” is not limited to multiple components or specific aspects. For example, a system may be implemented on one or more printed circuit boards or other substrates, and may have movable or static components. While the below description and examples use the term “system” to describe various aspects of this disclosure, the term “system” is not limited to a specific configuration, type, or number of objects.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as flash memory, memory or memory devices, magnetic or optical disks, flash memory, USB devices provided with non-volatile memory, networked storage devices, compact disk (CD) or digital versatile disk (DVD), any suitable combination thereof, among others. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include:

Aspect 1. An apparatus comprising: at least one memory; and at least one processor coupled to the at least one memory and configured to: obtain a first set of parameter values corresponding to parameters of a simulator model; process stochastic input data associated with the simulator model and the first set of parameter values using a surrogate neural network to generate one or more surrogate predictions, wherein the surrogate neural network is trained to approximate the simulator model; generate a state vector indicative of the first set of parameter values for the simulator model and the one or more surrogate predictions; determine an action corresponding to a trained agent of a reinforcement learning (RL)-based policy network, wherein the action is determined based on the state vector, and wherein the action is indicative of a decision to re-train the surrogate neural network or a decision not to re-train the surrogate neural network; and generate a second set of parameter values corresponding to the parameters of the simulator model, wherein the second set of parameter values are generated based on using the action and one or more gradients determined for the surrogate neural network to update the first set of parameter values.

Aspect 2. The apparatus of Aspect 1, wherein the at least one processor is configured to: re-train the surrogate neural network based on the action being indicative of the decision to re-train the surrogate neural network.

Aspect 3. The apparatus of Aspect 2, wherein, to re-train the surrogate neural network, the at least one processor is configured to: perform a simulator call between the trained agent and the simulator model, wherein the simulator call corresponds to evaluating a forward process of the simulator model; and re-train the surrogate neural network using a dataset sampled from a local neighborhood within a current set of parameter values associated with evaluating the forward process of the simulator model.

Aspect 4. The apparatus of Aspect 3, wherein: the stochastic input data is sampled from an input distribution associated with the simulator model; and the at least one processor is configured to re-train the surrogate neural network using the dataset sampled from the local neighborhood within the current set of parameter values and further using a plurality of input data samples sampled from the input distribution.

Aspect 5. The apparatus of any of Aspects 3 to 4, wherein the action corresponding to the trained agent is indicative of: a decision variable indicative of the decision to re-train or the decision not to re-train the surrogate neural network; and one or more values indicative of a window size for the local neighborhood within the current set of parameter values associated with evaluating the forward process of the simulator model.

Aspect 6. The apparatus of Aspect 5, wherein the one or more values comprise a mean value and a standard deviation value associated with a lognormal distribution determined by the trained agent, and wherein the window size is sampled from the lognormal distribution using the mean value and the standard deviation value.

Aspect 7. The apparatus of any of Aspects 1 to 6, wherein the simulator is a non-differentiable stochastic simulator, and wherein the surrogate neural network is a learned differentiable model trained to approximate the non-differentiable stochastic simulator.

Aspect 8. The apparatus of any of Aspects 1 to 7, wherein, to re-train the surrogate neural network, the at least one processor is configured to: obtain a training dataset comprising data sampled from the simulator model; and re-train the surrogate neural network using the data sampled from the simulator model.

Aspect 9. The apparatus of Aspect 8, wherein the at least one processor is configured to determine the one or more gradients after the surrogate neural network is re-trained.

Aspect 10. The apparatus of any of Aspects 1 to 9, wherein the trained agent of the RL-based policy network is an actor-critic reinforcement learning agent comprising an actor neural network and a critic neural network.

Aspect 11. The apparatus of Aspect 10, wherein: the actor neural network comprises a first multilayer perceptron (MLP) configured to determine the action based on an input comprising the state vector; and the critic neural network comprises a second MLP configured to determine a value function estimate based on the state vector.

Aspect 12. The apparatus of any of Aspects 10 to 11, wherein the trained agent is a reinforcement learning agent trained based on a reward model including a first configured threshold value corresponding to a maximum of time steps and a second configured threshold value corresponding to a maximum number of simulator calls between the trained agent and the simulator model.

Aspect 13. The apparatus of Aspect 12, wherein the reward model further includes a third configured threshold value corresponding to an objective function determined based on the parameters of the simulator model.

Aspect 14. The apparatus of any of Aspects 12 to 13, wherein the agent is configured to perform a simulator call based on the decision to re-train the surrogate neural network.

Aspect 15. The apparatus of any of Aspects 1 to 14, wherein the state vector is indicative of: a current time step of the trained agent; a current set of parameter values corresponding to the parameters of the simulator model and determined for the current time step; a number of simulator calls performed within a current reinforcement learning episode of the trained agent; and uncertainty information associated with the one or more surrogate predictions.

Aspect 16. The apparatus of any of Aspects 1 to 15, wherein: the state vector is indicative of the one or more surrogate predictions based on the state vector including uncertainty information corresponding to an ensemble of a plurality of surrogate neural networks including the surrogate neural network.

Aspect 17. The apparatus of Aspect 16, wherein: each respective surrogate neural network of the plurality of surrogate neural networks generates a respective surrogate prediction based on the stochastic input data and the first set of parameter values; and the state vector includes uncertainty information comprising an ensemble uncertainty indicative of an average standard deviation over the respective surrogate predictions.

Aspect 18. A method comprising: obtaining a first set of parameter values corresponding to parameters of a simulator model; processing stochastic input data associated with the simulator model and the first set of parameter values using a surrogate neural network to generate one or more surrogate predictions, wherein the surrogate neural network is trained to approximate the simulator model; generating a state vector indicative of the first set of parameter values for the simulator model and the one or more surrogate predictions; determining an action corresponding to a trained agent of a reinforcement learning (RL)-based policy network, wherein the action is determined based on the state vector, and wherein the action is indicative of a decision to re-train the surrogate neural network or a decision not to re-train the surrogate neural network; and generating a second set of parameter values corresponding to the parameters of the simulator model, wherein the second set of parameter values are generated based on using the action and one or more gradients determined for the surrogate neural network to update the first set of parameter values.

Aspect 19. The method of Aspect 18, further comprising: re-training the surrogate neural network based on the action being indicative of the decision to re-train the surrogate neural network.

Aspect 20. The method of Aspect 19, wherein re-training the surrogate neural network comprises: performing a simulator call between the trained agent and the simulator model, wherein the simulator call corresponds to evaluating a forward process of the simulator model; and re-training the surrogate neural network using a dataset sampled from a local neighborhood within a current set of parameter values associated with evaluating the forward process of the simulator model.

Aspect 21. The method of Aspect 20, further comprising: sampling the stochastic input data from an input distribution associated with the simulator model; and re-training the surrogate neural network using the dataset sampled from the local neighborhood within the current set of parameter values and further using a plurality of input data samples sampled from the input distribution.

Aspect 22. The method of any of Aspects 20 to 21, wherein the action corresponding to the trained agent is indicative of: a decision variable indicative of the decision to re-train or the decision not to re-train the surrogate neural network; and one or more values indicative of a window size for the local neighborhood within the current set of parameter values associated with evaluating the forward process of the simulator model.

Aspect 23. The method of Aspect 22, wherein the one or more values comprise a mean value and a standard deviation value associated with a lognormal distribution determined by the trained agent, and wherein the window size is sampled from the lognormal distribution using the mean value and the standard deviation value.

Aspect 24. The method of any of Aspects 18 to 23, wherein the simulator is a non-differentiable stochastic simulator, and wherein the surrogate neural network is a learned differentiable model trained to approximate the non-differentiable stochastic simulator.

Aspect 25. The method of any of Aspects 18 to 24, wherein re-training the surrogate neural network comprises: obtaining a training dataset comprising data sampled from the simulator model; and re-training the surrogate neural network using the data sampled from the simulator model.

Aspect 26. The method of Aspect 25, further comprising determining the one or more gradients after the surrogate neural network is re-trained.

Aspect 27. The method of any of Aspects 18 to 26, wherein the trained agent of the RL-based policy network is an actor-critic reinforcement learning agent comprising an actor neural network and a critic neural network.

Aspect 28. The method of Aspect 27, wherein: the actor neural network comprises a first multilayer perceptron (MLP) configured to determine the action based on an input comprising the state vector; and the critic neural network comprises a second MLP configured to determine a value function estimate based on the state vector.

Aspect 29. The method of any of Aspects 27 to 28, wherein the trained agent is a reinforcement learning agent trained based on a reward model including a first configured threshold value corresponding to a maximum of time steps and a second configured threshold value corresponding to a maximum number of simulator calls between the trained agent and the simulator model.

Aspect 30. The method of Aspect 29, wherein the reward model further includes a third configured threshold value corresponding to an objective function determined based on the parameters of the simulator model.

Aspect 31. The method of any of Aspects 29 to 30, wherein the agent is configured to perform a simulator call based on the decision to re-train the surrogate neural network.

Aspect 32. The method of any of Aspects 18 to 31, wherein the state vector is indicative of: a current time step of the trained agent; a current set of parameter values corresponding to the parameters of the simulator model and determined for the current time step; a number of simulator calls performed within a current reinforcement learning episode of the trained agent; and uncertainty information associated with the one or more surrogate predictions.

Aspect 33. The method of any of Aspects 18 to 32, wherein: the state vector is indicative of the one or more surrogate predictions based on the state vector including uncertainty information corresponding to an ensemble of a plurality of surrogate neural networks including the surrogate neural network.

Aspect 34. The method of Aspect 33, wherein: each respective surrogate neural network of the plurality of surrogate neural networks generates a respective surrogate prediction based on the stochastic input data and the first set of parameter values; and the state vector includes uncertainty information comprising an ensemble uncertainty indicative of an average standard deviation over the respective surrogate predictions.

Aspect 35. A non-transitory computer-readable medium having stored thereon instructions that, when executed by one or more processors, cause the one or more processors to: obtain a first set of parameter values corresponding to parameters of a simulator model; process stochastic input data associated with the simulator model and the first set of parameter values using a surrogate neural network to generate one or more surrogate predictions, wherein the surrogate neural network is trained to approximate the simulator model; generate a state vector indicative of the first set of parameter values for the simulator model and the one or more surrogate predictions; determine an action corresponding to a trained agent of a reinforcement learning (RL)-based policy network, wherein the action is determined based on the state vector, and wherein the action is indicative of a decision to re-train the surrogate neural network or a decision not to re-train the surrogate neural network; and generate a second set of parameter values corresponding to the parameters of the simulator model, wherein the second set of parameter values are generated based on using the action and one or more gradients determined for the surrogate neural network to update the first set of parameter values.

Aspect 36. The non-transitory computer-readable medium of Aspect 35, wherein the instructions further cause the one or more processors to: re-train the surrogate neural network based on the action being indicative of the decision to re-train the surrogate neural network.

Aspect 37. The non-transitory computer-readable medium of Aspect 36, wherein, to re-train the surrogate neural network, the instructions cause the one or more processors to: perform a simulator call between the trained agent and the simulator model, wherein the simulator call corresponds to evaluating a forward process of the simulator model; and re-train the surrogate neural network using a dataset sampled from a local neighborhood within a current set of parameter values associated with evaluating the forward process of the simulator model.

Aspect 38. The non-transitory computer-readable medium of Aspect 37, wherein the instructions cause the one or more processors to: sample the stochastic input data from an input distribution associated with the simulator model; and re-train the surrogate neural network using the dataset sampled from the local neighborhood within the current set of parameter values and further using a plurality of input data samples sampled from the input distribution.

Aspect 39. The non-transitory computer-readable medium of any of Aspects 37 to 38, wherein the action corresponding to the trained agent is indicative of: a decision variable indicative of the decision to re-train or the decision not to re-train the surrogate neural network; and one or more values indicative of a window size for the local neighborhood within the current set of parameter values associated with evaluating the forward process of the simulator model.

Aspect 40. The non-transitory computer-readable medium of Aspect 39, wherein the one or more values comprise a mean value and a standard deviation value associated with a lognormal distribution determined by the trained agent, and wherein the window size is sampled from the lognormal distribution using the mean value and the standard deviation value.

Aspect 41. The non-transitory computer-readable medium of any of Aspects 35 to 40, wherein the simulator is a non-differentiable stochastic simulator, and wherein the surrogate neural network is a learned differentiable model trained to approximate the non-differentiable stochastic simulator.

Aspect 42. The non-transitory computer-readable medium of any of Aspects 35 to 41, wherein, to re-train the surrogate neural network, the instructions cause the one or more processors to: obtain a training dataset comprising data sampled from the simulator model; and re-train the surrogate neural network using the data sampled from the simulator model.

Aspect 43. The non-transitory computer-readable medium of Aspect 42 wherein the instructions cause the one or more processors to determine the one or more gradients after the surrogate neural network is re-trained.

Aspect 44. The non-transitory computer-readable medium of any of Aspects 35 to 43, wherein the trained agent of the RL-based policy network is an actor-critic reinforcement learning agent comprising an actor neural network and a critic neural network.

Aspect 45. The non-transitory computer-readable medium of Aspect 44, wherein: the actor neural network comprises a first multilayer perceptron (MLP) configured to determine the action based on an input comprising the state vector; and the critic neural network comprises a second MLP configured to determine a value function estimate based on the state vector.

Aspect 46. The non-transitory computer-readable medium of any of Aspects 44 to 45, wherein the trained agent is a reinforcement learning agent trained based on a reward model including a first configured threshold value corresponding to a maximum of time steps and a second configured threshold value corresponding to a maximum number of simulator calls between the trained agent and the simulator model.

Aspect 47. The non-transitory computer-readable medium of Aspect 46, wherein the reward model further includes a third configured threshold value corresponding to an objective function determined based on the parameters of the simulator model.

Aspect 48. The non-transitory computer-readable medium of any of Aspects 46 to 47, wherein the agent is configured to perform a simulator call based on the decision to re-train the surrogate neural network.

Aspect 49. The non-transitory computer-readable medium of any of Aspects 35 to 48, wherein the state vector is indicative of: a current time step of the trained agent; a current set of parameter values corresponding to the parameters of the simulator model and determined for the current time step; a number of simulator calls performed within a current reinforcement learning episode of the trained agent; and uncertainty information associated with the one or more surrogate predictions.

Aspect 50. The non-transitory computer-readable medium of any of Aspects 35 to 49, wherein: the state vector is indicative of the one or more surrogate predictions based on the state vector including uncertainty information corresponding to an ensemble of a plurality of surrogate neural networks including the surrogate neural network.

Aspect 51. The non-transitory computer-readable medium of Aspect 50, wherein: each respective surrogate neural network of the plurality of surrogate neural networks generates a respective surrogate prediction based on the stochastic input data and the first set of parameter values; and the state vector includes uncertainty information comprising an ensemble uncertainty indicative of an average standard deviation over the respective surrogate predictions.

Aspect 52. A non-transitory computer-readable storage medium comprising instructions stored thereon which, when executed by at least one processor, causes the at least one processor to perform operations according to any of Aspects 1 to 51.

Aspect 53. An apparatus comprising one or more means for performing operations according to any of Aspects 1 to 51.

What is claimed is:

1. An apparatus comprising:
at least one memory; and
at least one processor coupled to the at least one memory and configured to:
obtain a first set of parameter values corresponding to parameters of a simulator model;
process stochastic input data associated with the simulator model and the first set of parameter values using a surrogate neural network to generate one or more surrogate predictions, wherein the surrogate neural network is trained to approximate the simulator model;
generate a state vector indicative of the first set of parameter values for the simulator model and the one or more surrogate predictions;
determine an action corresponding to a trained agent of a reinforcement learning (RL)-based policy network, wherein the action is determined based on the state vector, and wherein the action is indicative of a decision to re-train the surrogate neural network or a decision not to re-train the surrogate neural network; and
generate a second set of parameter values corresponding to the parameters of the simulator model, wherein the second set of parameter values are generated based on using the action and one or more gradients determined for the surrogate neural network to update the first set of parameter values.

2. The apparatus of claim 1, wherein the at least one processor is configured to:
re-train the surrogate neural network based on the action being indicative of the decision to re-train the surrogate neural network.

3. The apparatus of claim 2, wherein, to re-train the surrogate neural network, the at least one processor is configured to:
perform a simulator call between the trained agent and the simulator model, wherein the simulator call corresponds to evaluating a forward process of the simulator model; and
re-train the surrogate neural network using a dataset sampled from a local neighborhood within a current set of parameter values associated with evaluating the forward process of the simulator model.

4. The apparatus of claim 3, wherein:
the stochastic input data is sampled from an input distribution associated with the simulator model; and
the at least one processor is configured to re-train the surrogate neural network using the dataset sampled from the local neighborhood within the current set of parameter values and further using a plurality of input data samples sampled from the input distribution.

5. The apparatus of claim 3, wherein the action corresponding to the trained agent is indicative of:
a decision variable indicative of the decision to re-train or the decision not to re-train the surrogate neural network; and
one or more values indicative of a window size for the local neighborhood within the current set of parameter values associated with evaluating the forward process of the simulator model.

6. The apparatus of claim 5, wherein the one or more values comprise a mean value and a standard deviation value associated with a lognormal distribution determined by the trained agent, and wherein the window size is sampled from the lognormal distribution using the mean value and the standard deviation value.

7. The apparatus of claim 1, wherein the simulator is a non-differentiable stochastic simulator, and wherein the surrogate neural network is a learned differentiable model trained to approximate the non-differentiable stochastic simulator.

8. The apparatus of claim 1, wherein, to re-train the surrogate neural network, the at least one processor is configured to:
obtain a training dataset comprising data sampled from the simulator model; and
re-train the surrogate neural network using the data sampled from the simulator model.

9. The apparatus of claim 8, wherein the at least one processor is configured to determine the one or more gradients after the surrogate neural network is re-trained.

10. The apparatus of claim 1, wherein the trained agent of the RL-based policy network is an actor-critic reinforcement learning agent comprising an actor neural network and a critic neural network.

11. The apparatus of claim 10, wherein:
the actor neural network comprises a first multilayer perceptron (MLP) configured to determine the action based on an input comprising the state vector; and
the critic neural network comprises a second MLP configured to determine a value function estimate based on the state vector.

12. The apparatus of claim 10, wherein the trained agent is a reinforcement learning agent trained based on a reward model including a first configured threshold value corresponding to a maximum of time steps and a second configured threshold value corresponding to a maximum number of simulator calls between the trained agent and the simulator model.

13. The apparatus of claim 12, wherein the reward model further includes a third configured threshold value corresponding to an objective function determined based on the parameters of the simulator model.

14. The apparatus of claim 12, wherein the agent is configured to perform a simulator call based on the decision to re-train the surrogate neural network.

15. The apparatus of claim 1, wherein the state vector is indicative of:
a current time step of the trained agent;
a current set of parameter values corresponding to the parameters of the simulator model and determined for the current time step;
a number of simulator calls performed within a current reinforcement learning episode of the trained agent; and
uncertainty information associated with the one or more surrogate predictions.

16. The apparatus of claim 1, wherein:
the state vector is indicative of the one or more surrogate predictions based on the state vector including uncertainty information corresponding to an ensemble of a plurality of surrogate neural networks including the surrogate neural network.

17. The apparatus of claim 16, wherein:
each respective surrogate neural network of the plurality of surrogate neural networks generates a respective surrogate prediction based on the stochastic input data and the first set of parameter values; and
the state vector includes uncertainty information comprising an ensemble uncertainty indicative of an average standard deviation over the respective surrogate predictions.

18. A method comprising:
obtaining a first set of parameter values corresponding to parameters of a simulator model;
processing stochastic input data associated with the simulator model and the first set of parameter values using a surrogate neural network to generate one or more surrogate predictions, wherein the surrogate neural network is trained to approximate the simulator model;
generating a state vector indicative of the first set of parameter values for the simulator model and the one or more surrogate predictions;
determining an action corresponding to a trained agent of a reinforcement learning (RL)-based policy network, wherein the action is determined based on the state vector, and wherein the action is indicative of a decision to re-train the surrogate neural network or a decision not to re-train the surrogate neural network; and
generating a second set of parameter values corresponding to the parameters of the simulator model, wherein the second set of parameter values are generated based on using the action and one or more gradients determined for the surrogate neural network to update the first set of parameter values.

19. The method of claim 18, further comprising re-training the surrogate neural network based on the action being indicative of the decision to re-train the surrogate neural network, wherein re-training the surrogate neural network comprises:
performing a simulator call between the trained agent and the simulator model, wherein the simulator call corresponds to evaluating a forward process of the simulator model; and
re-training the surrogate neural network using a dataset sampled from a local neighborhood within a current set of parameter values associated with evaluating the forward process of the simulator model.

20. A non-transitory computer-readable medium having stored thereon instructions that, when executed by one or more processors, cause the one or more processors to:
obtain a first set of parameter values corresponding to parameters of a simulator model;
process stochastic input data associated with the simulator model and the first set of parameter values using a surrogate neural network to generate one or more surrogate predictions, wherein the surrogate neural network is trained to approximate the simulator model;
generate a state vector indicative of the first set of parameter values for the simulator model and the one or more surrogate predictions;
determine an action corresponding to a trained agent of a reinforcement learning (RL)-based policy network, wherein the action is determined based on the state vector, and wherein the action is indicative of a decision to re-train the surrogate neural network or a decision not to re-train the surrogate neural network; and
generate a second set of parameter values corresponding to the parameters of the simulator model, wherein the second set of parameter values are generated based on using the action and one or more gradients determined for the surrogate neural network to update the first set of parameter values.
